(19) United States
(12) Patent Application Publication
(10) Pub. No.: US 2013/0107545 A1
(43) Pub. Date: May 2, 2013

(54) BULB CAP AND LAMP WITH APPLICATION THEREOF

(71) Applicants: Tsai-Lin Tai, Kaohsiung City (TW); Chun-Chuan Lin, Hsinchu City (TW); Hsiu-Hsiang Chen, Hsinchu County (TW); Hsin-Hsiang Lo, Hsinchu County (TW); Chu-Hsun Lin, Taoyuan County (TW)

(72) Inventors: Tsai-Lin Tai, Kaohsiung City (TW); Chun-Chuan Lin, Hsinchu City (TW); Hsiu-Hsiang Chen, Hsinchu County (TW); Hsin-Hsiang Lo, Hsinchu County (TW); Chu-Hsun Lin, Taoyuan County (TW)

(73) Assignee: INDUSTRIAL TECHNOLOGY RESEARCH INSTITUTE, Hsinchu (TW)

(21) Appl. No.: 13/337,304

(22) Filed: Dec. 27, 2011

(30) Foreign Application Priority Data
Oct. 27, 2011 (TW) 100139128

(51) Int. Cl. F21V 3/02

(52) U.S. Cl. 362/363

(57) ABSTRACT

A bulb cap is mounted on a base and includes an elastic translucent cap and a gas injecting device. The elastic translucent cap has an initial geometric shape and a thickness-distribution structure. The gas injecting device is coupled to the elastic translucent cap. After the elastic translucent cap is mounted at the base, gas with a gas-pressure can be injected by using the gas injecting device so that the elastic translucent cap is expanded to a geometric shape structure corresponding to the gas-pressure to change a light pattern of the base, and meanwhile the geometric shape structure is varied with the gas-pressure. In addition, the elastic translucent cap can be replaced by a bulb cap with a fixed geometric shape.

### CROSS-REFERENCE TO RELATED APPLICATION

This application claims the priority benefit of Taiwan application serial no. 100139128, filed on Oct. 27, 2011. The entirety of the above-mentioned patent application is hereby incorporated by reference herein and made a part of this specification.

### BACKGROUND OF THE INVENTION

1. Technical Field

The disclosure relates to a lamp technology.

2. Background

The traditional lamp structure usually includes a filament serving as a light source. In addition, the filament is covered by a bulb. The surface of the bulb has a frosted scatter surface, that is, a frosted bulb in general use, where the light emitted from the filament can be more uniform and softly scattered out to avoid stimulating eyes. However, the lamp with the use of filament for emitting light would produce considerably-high temperature to make the bulb quite hot. Usually, there will be no lamp cap directly disposed on the traditional bulb.

Another traditional lamp is based on a fluorescence light mechanism, where a specific gas is injected into the bulb and is used to emit fluorescence light. It is just like a common electricity-saving bulb, but the bulb body is still hot.

Further, there is a lamp with a light-emitting diode (LED) serving as a light source, which saves electricity and the surface of the bulb has a lower temperature.

The traditional lamp cap can not change the emitting light pattern to adapt the environment or the application requirement, and the lamp cap has a fixed geometric shape usually for a decoration consideration.

Based on the description above, how to improve at least the illumination function by a designing on bulb cap (lamp cap) becomes one of issues for development to be necessarily considered.

### SUMMARY

The disclosure provides a bulb cap with variable light pattern. The bulb cap with variable light pattern is mounted at a base and includes an elastic translucent cap and a gas injecting device. The elastic translucent cap has an initial geometric shape and a thickness-distribution structure. The gas injecting device is coupled to the elastic translucent cap. After the elastic translucent cap is mounted on the base, gas with a gas-pressure can be injected by using the gas injecting device. The elastic translucent cap is expanded to a geometric shape structure corresponding to the level of gas-pressure to change a light pattern of emitting light or receiving light by the base, and meanwhile the geometric shape structure is varied with the gas-pressure.

The disclosure also provides a lamp including a bulb, an elastic translucent cap and a gas injecting device. The elastic translucent cap has an initial geometric shape and a thickness-distribution structure. The gas injecting device is coupled to the elastic translucent cap. After the elastic translucent cap is mounted on the base, gas with a gas-pressure can be injected by using the gas injecting device so that the elastic translucent cap is expanded to a geometric shape structure corresponding to the gas-pressure to change a light pattern of the bulb, and meanwhile the geometric shape structure is varied with the gas-pressure.

The disclosure further provides a bulb cap with variable light pattern, the bulb cap is mounted at a base and includes a geometric shape structure to be mounted on the base. After the bulb cap is mounted on the base, the geometric shape structure changes the light pattern of the base for emitting or receiving light.

The disclosure moreover provides a lamp, the lamp includes a bulb and a bulb cap with a geometric shape structure to be mounted on the bulb. After the bulb cap is mounted on the bulb, the geometric shape structure changes the light pattern of the bulb.

Several exemplary embodiments accompanied with figures are described in detail below to further describe the disclosure.

### BRIEF DESCRIPTION OF THE DRAWINGS

The accompanying drawings are included to provide further understanding, and are incorporated in and constitute a part of this specification. The drawings illustrate exemplary embodiments and, together with the description, serve to explain the principles of the disclosure.

FIG. 1 is a schematic sectional diagram of a lamp with variable light pattern according to an embodiment of the disclosure.

FIG. 2 is a schematic sectional diagram of a lamp with variable light pattern according to an embodiment of the disclosure.

FIGS. 3A-3G are schematic diagrams showing different geometric shapes of a lamp with variable light pattern after the bulb cap is injected according to an embodiment of the disclosure.

FIG. 3H is a schematic distribution diagram of the intensity of light according to the shape of the bulb cap in FIG. 3A.

FIGS. 4A-4G are schematic perspective and 6-views diagrams showing different geometric shapes of a lamp with variable light pattern after the bulb cap is injected according to an embodiment of the disclosure.

FIG. 4H is a schematic distribution diagram of the intensity of light according to the shape.

FIGS. 5A-5G are schematic diagrams showing different geometric shapes of a lamp with variable light pattern after the bulb cap is injected according to an embodiment of the disclosure.

FIG. 5H is a schematic distribution diagram of the intensity of light according to the shape of the bulb cap in FIG. 5A.

FIGS. 6A-6G are schematic perspective and 6-views diagrams showing different geometric shapes of a lamp with variable light pattern after the bulb cap is injected according to an embodiment of the disclosure.

FIG. 6H is a schematic distribution diagram of the intensity of light according to the shape of the bulb cap in FIG. 6A.

FIGS. 7A-7G are schematic perspective and 6-views diagrams showing different geometric shapes of a lamp with variable light pattern after the bulb cap is injected according to an embodiment of the disclosure.

FIG. 7H is a schematic distribution diagram of the intensity of light according to the shape of the bulb cap in FIG. 7A.

FIGS. 8A-8G are schematic perspective and 6-views diagrams showing different geometric shapes of a lamp with variable light pattern after the bulb cap is injected according to an embodiment of the disclosure.

FIG. 8H is a schematic distribution diagram of the intensity of light according to the shape of the bulb cap in FIG. 8A.

FIGS. 9A-9G are schematic perspective and 6-views diagrams showing different geometric shapes of a lamp with variable light pattern after the bulb cap is injected according to an embodiment of the disclosure.

FIG. 9H is a schematic distribution diagram of the intensity of light according to the shape of the bulb cap in FIG. 9A.

FIGS. 10A-10G are schematic perspective and 6-views diagrams showing different geometric shapes of a lamp with variable light pattern after the bulb cap is injected according to an embodiment of the disclosure.

FIG. 10H is a schematic distribution diagram of the intensity of light according to the shape of the bulb cap in FIG. 10A.

FIGS. 11A-11G are schematic perspective and 6-views diagrams showing different geometric shapes of a lamp with variable light pattern after the bulb cap is injected according to an embodiment of the disclosure.

FIG. 11H is a schematic distribution diagram of the intensity of light according to the shape of the bulb cap in FIG. 11A.

FIGS. 12A-12G are schematic perspective and 6-views diagrams showing different geometric shapes of a lamp with variable light pattern after the bulb cap is detached according to an embodiment of the disclosure.

FIG. 12H is a schematic distribution diagram of the intensity of light according to the shape of the bulb cap in FIG. 12A.

### DETAILED DESCRIPTION OF DISCLOSED EMBODIMENTS

The disclosure provides a bulb cap with changeable shape, the opening-end thereof is, for example, connected to a bulb and the bulb cap can change the shape of the casing thereof by injecting gas or injecting liquid. When light transmits through the bulb cap with different shapes, the emitting light pattern can vary with the changed shapes. In this way, the shape of the lamp cap can be changed to meet the demands of light patterns for different circumstances and different topographies.

The bulb cap with variable light pattern in the disclosure is an elastic translucent cap with an opening-end and a casing. The casing is made of an elastic translucent material, such as PC, PP, PET, or silica gel, and the shape of the casing can be changed by gas injecting way according to the illumination requirement. The transmittance of the translucent material depends on the actual requirement, and it may range from 0% to 100%.

The casing is configured to have an equal thickness or unequal thicknesses. In addition, the casing is configured to be axial-symmetry shape or not axial-symmetry shape, and there is at least one gas injecting device, such as an intake valve, is disposed outside of the casing. After connecting the bulb cap to a lamp light source, the variable light pattern can be changed according to different demands.

By changing the shape of the bulb cap through gas injecting operations to change the light pattern, a decoration effect can be achieved and it can further be used in illumination for changing light. The angle range of the emitted light herein is close to the angle range of the emitted light of the traditional tungsten bulb and is able to overcome the limitation of the emitting angle of the LED light. In addition, the bulb cap with variable light pattern can further achieve different light pattern effects through changing its shape according to different demands.

Another sort of elastic bulb cap with changeable shape can be used on a solar energy collector, where a solar panel is placed inside the bulb cap. The solar energy collector can be put in the sky with several meters height to operate as a mini power plant. However, the conventional design is unable to overcome the problem of sun light's incidence angle. If the disclosure is used on a solar energy balloon, it can change the shape of the bulb cap according to different incidence angles of sunlight. The condensing efficiency of the solar panel can be greatly improved. In other words, if the bulb of the solar energy balloon is an elastic bulb cap with changeable shape, it can effectively collect the light onto a solar energy chip inside the bulb cap.

The elastic bulb cap is not limited to be used on a bulb. In general, the elastic bulb cap can be mounted on a base to change light pattern for emitting or receiving light.

Some embodiments are described in following to explain the disclosure, which the disclosure is not limited to. In addition, feasible combinations between the embodiments are allowed.

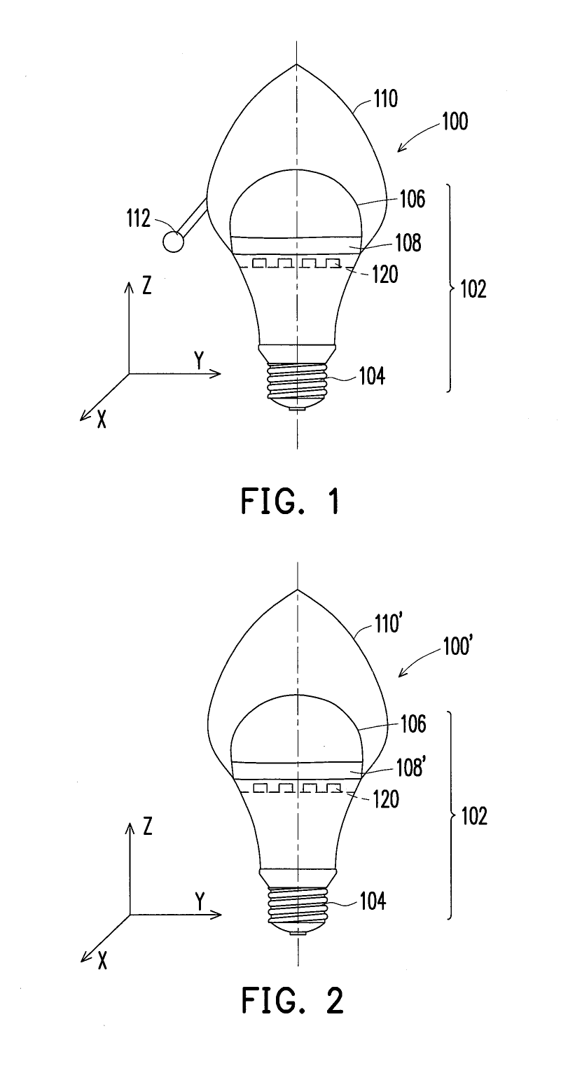

FIG. 1 is a schematic sectional diagram of a lamp with variable light pattern according to an embodiment of the disclosure. Referring to FIG. 1, the embodiment is described for a lamp as an example. A lamp with variable light pattern 100 in the embodiment includes a lamp 102 and an elastic translucent cap 110. The lamp 102 herein serves as a base and can be a general traditional lamp, such as a luminescence lamp or a lamp by using an LED 120 as a light source. The lamp 102 is operated by electrically coupling a terminal 104 to an electrical power. The bulb 106 covers the LED 120 and can have a frosted surface structure in an example. However, the frosted surface structure is not necessary to be a limitation in the embodiments.

An elastic translucent cap 110 is coupled to the bulb 106 in the embodiment, in which the opening-end of the elastic translucent cap 110 has a coupling structure 108 to mount the elastic translucent cap 110 at the bulb 106 in an example to mount the elastic translucent cap 110 over the bulb 106. The elastic translucent cap 110 has a thickness-distribution structure, which can be an equal thickness distribution pattern or an unequal thickness distribution pattern. The function of the thickness-distribution structure would be explained latter. The so-called translucent property is depending on the light source to be used. In an example for general illumination, it means “penetration” of visible light. For light with other wavelengths, such as infrared or ultraviolet light, the translucent property is corresponding to infrared or ultraviolet light.

The coupling structure 108 can be directly disposed on the bulb 106 or at other locations of the lamp. A gas injecting device 112 is further implemented on the elastic translucent cap 110. Referring to the embodiment of FIG. 1, after the elastic translucent cap 110 is mounted on the bulb 106, gas with a gas-pressure can be injected by using the gas injecting device 112. The elastic translucent cap 110 is expanded to a geometric shape structure corresponding to the gas-pressure to change the light pattern of the lamp for emitting light, and meanwhile the geometric shape structure can vary with the gas-pressure.

The coupling structure 108 between the bulb cap and the lamp requires sealing and gas injecting functions, which includes a seal of sealing ring as an example to prevent leaking during gas injecting. The gas injecting device 112 can be disposed at any appropriate location, such as on the sealing ring where a gas injecting hole is preserved and the gas injecting device 112 is disposed. A ring-shape part can be added on the sealing ring to make the bulb cap and the sealing ring closely fit the lamp. For a lamp as an example by using an LED light source, the produced heat is a less and the temperature of the bulb 106 is lower. The implementation of the coupling structure 108 can be easy without considering the temperature issue.

The light source usually can be an LED bulb, an organic light-emitting diode bulb (OLED bulb) or a laser bulb, as the examples.

The elastic translucent cap 110 has an initial geometric shape and can be expanded depending on the injected gas with a gas-pressure to get deformation and change the light pattern. When the elastic translucent cap 110 is designed with different thickness distributions, the elastic translucent cap 110 can be expanded to different geometric shapes with different gas-pressures.

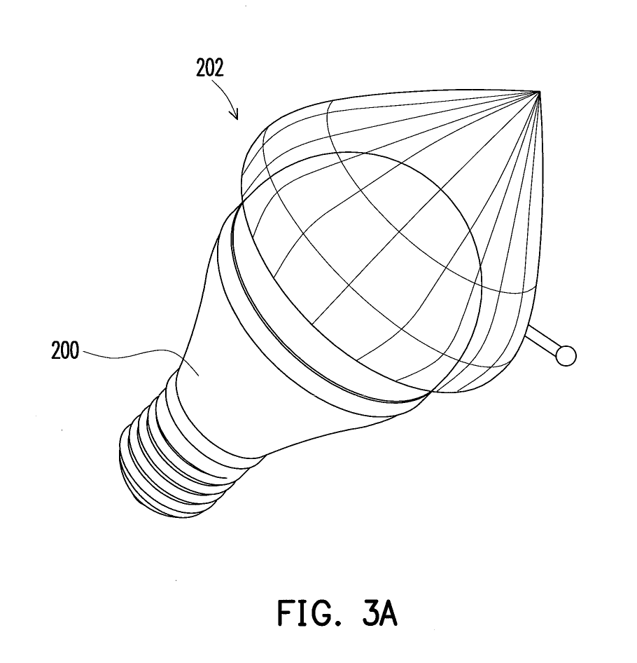

FIG. 2 is a schematic sectional diagram of a lamp with variable light pattern according to an embodiment of the disclosure. Referring to FIG. 2, a lamp with variable light pattern 100′ can adopt a bulb cap 110′ with a fixed geometric shape and is not made of an elastic material. Accordingly, a coupling structure 108′ can also be accordingly changed by screws for mounting purpose as an example. In fact, the embodiment does not limit to specific way for coupling. The elastic translucent cap 110 in the previous embodiment can be directly replaced as a choice.

The following several embodiments in association with the measurement by using an Ulbricht globe (integrating sphere photometer) are described to explain the changing of the light pattern.

The measurement configuration can refer to the coordination of FIG. 1. The central line of the lamp 100 is at the Z-axis direction as an example. An Ulbricht globe is disposed outside the lamp 100 and surrounds the lamp 100. The intensity of light is measured on the Ulbricht globe along the surface crossed by the XZ plane and the YZ plane, where the angle is the included angle with the +Z axis, 0° is the direction along the +Z axis and 180° is the direction along the −Z axis.

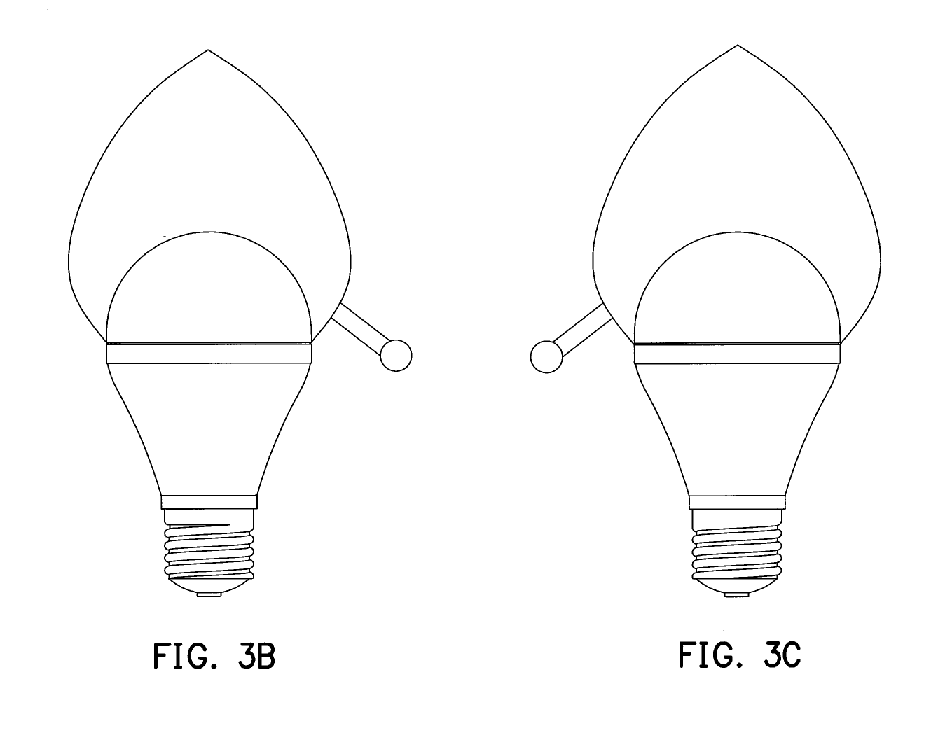

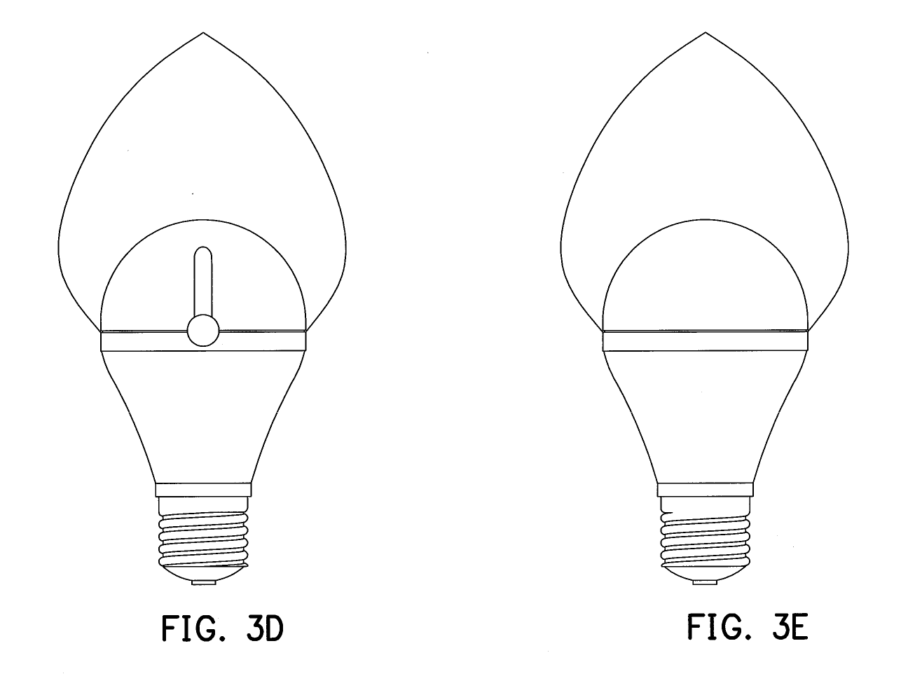

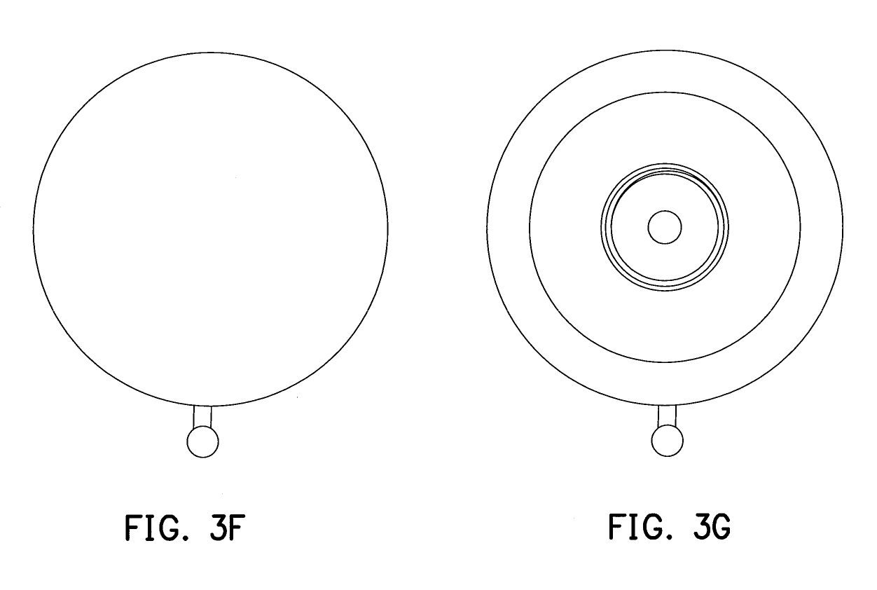

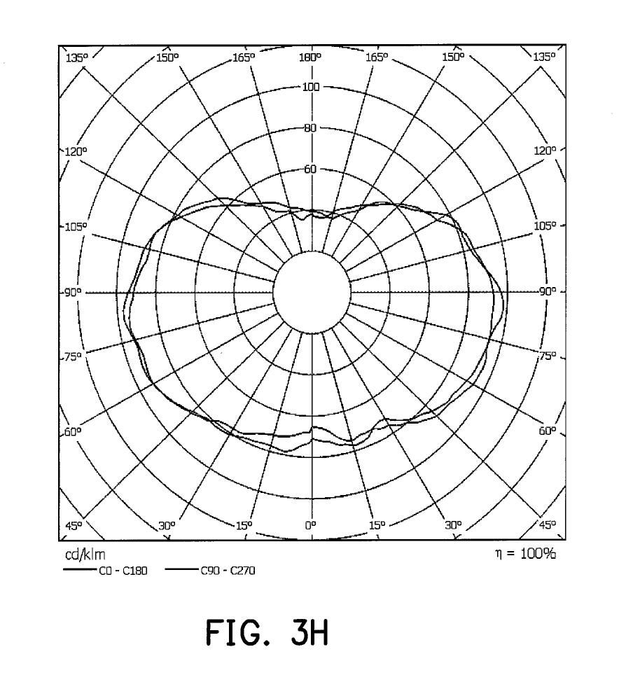

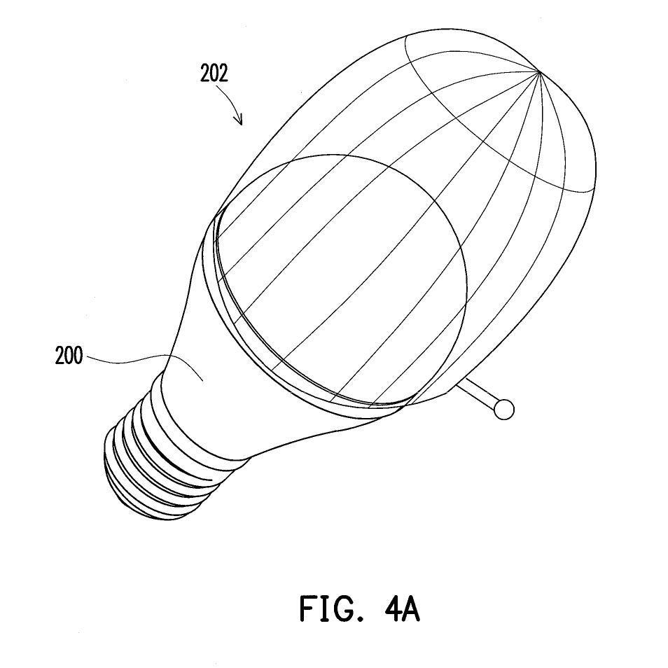

FIGS. 3A-3G are schematic perspective and 6-views diagrams showing different geometric shapes of a lamp with variable light pattern after the bulb cap is injected according to an embodiment of the disclosure. FIG. 3H is a schematic distribution diagram of the intensity of light according to the shape of the bulb cap in FIG. 3A.

Referring to FIGS. 3A-3G, an elastic translucent cap 202 is mounted on a lamp 200, in which the cross-section range of the elastic translucent cap 202 is greater than the cross-section range of the lamp 200 to produce some backward light. The elastic translucent cap 202 has a shape similar to a water drop or a candle light. Referring to FIG. 3H, since the cross-section range of the elastic translucent cap 202 is greater than the cross-section range of the lamp 200, somehow micro-luminance remains at the 180° area. The two curves in FIG. 3H represent intensities of light measured along a surface passing the XZ plane and crossing the YZ plane. For such light pattern, the primary light-emitting angle can reach a 0-105° ranch where the light is roughly uniformly emitted.

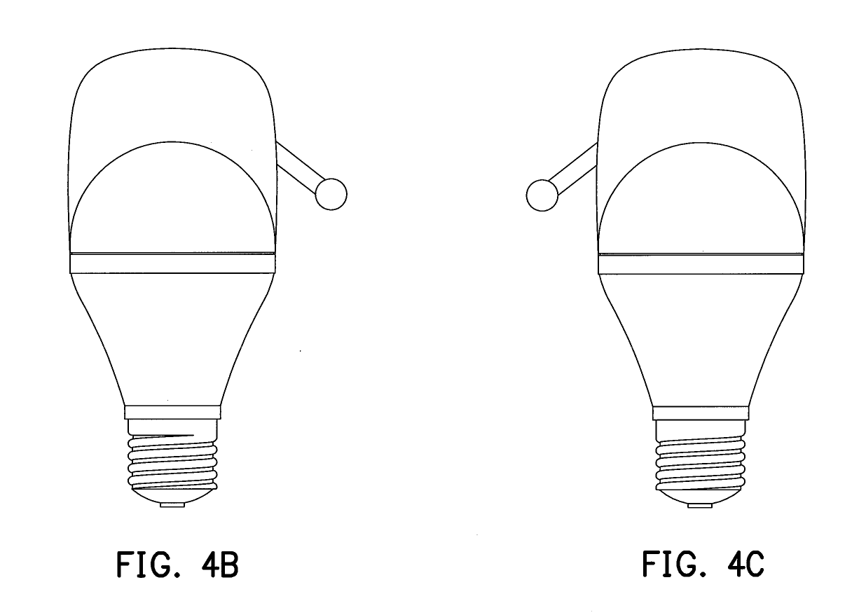

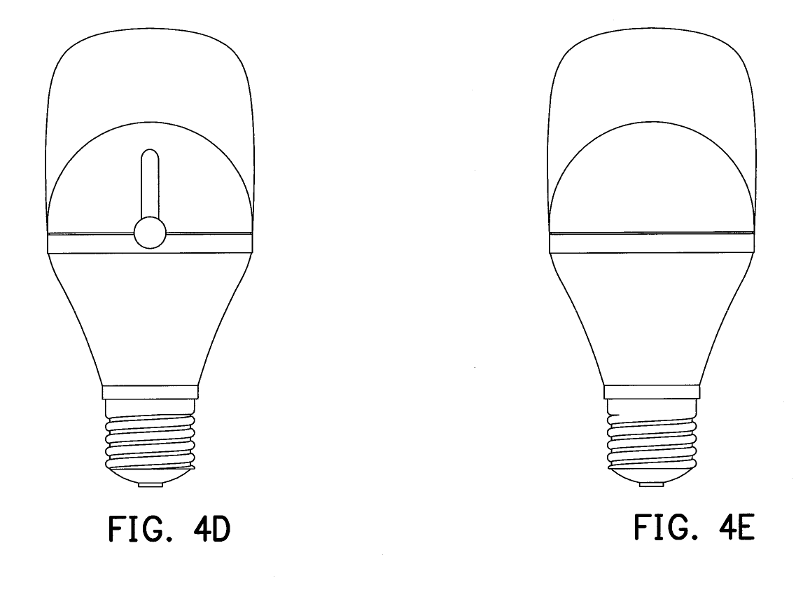

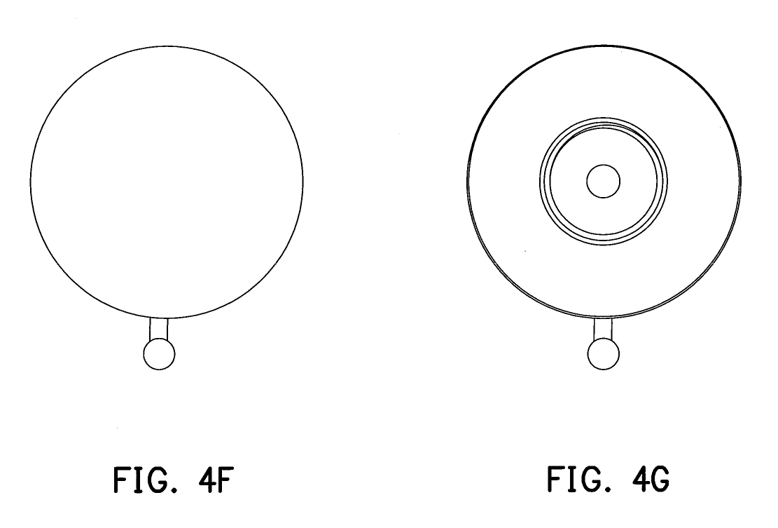

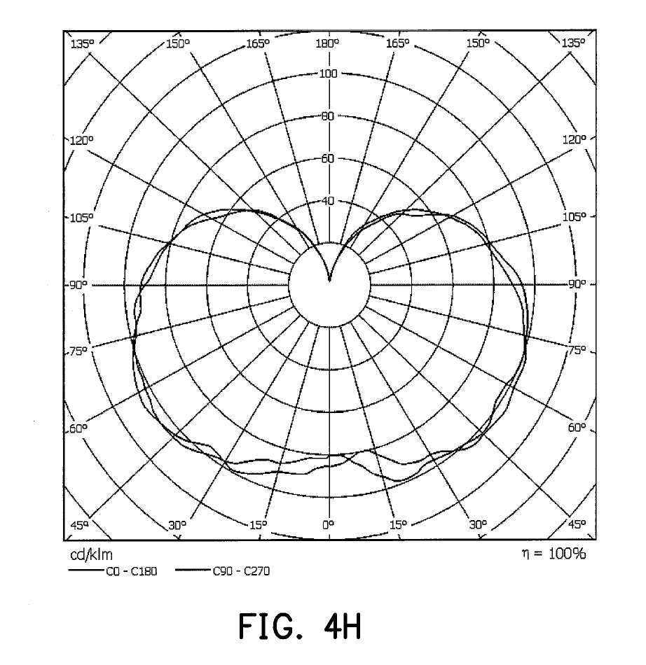

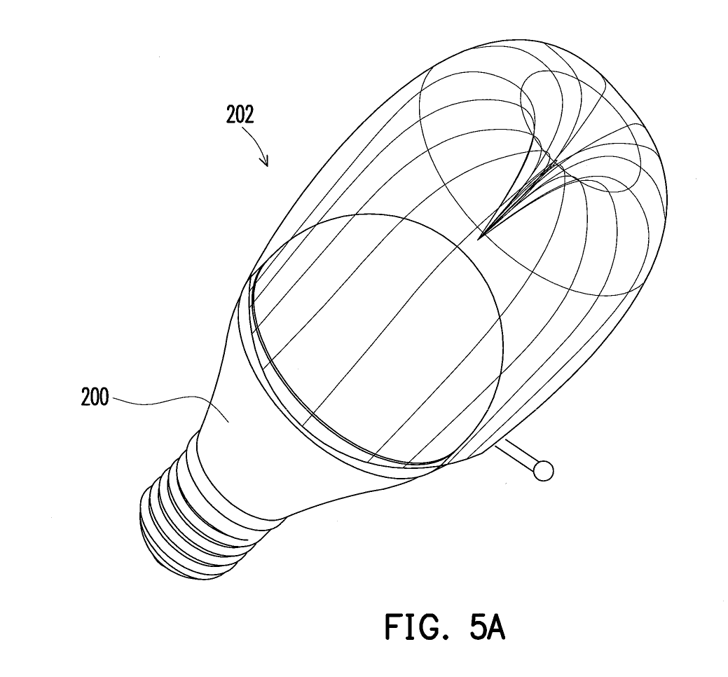

FIGS. 4A-4G are schematic perspective and 6-views diagrams showing different geometric shapes of a lamp with variable light pattern after the bulb cap is injected according to another embodiment of the disclosure. FIG. 4H is a schematic distribution diagram of the intensity of light according to the shape.

Referring to FIGS. 4A-4G, an elastic translucent cap 202 is mounted on a lamp 200, in which the cross-section range of the elastic translucent cap 202 is not greater than the cross-section range of the lamp 200 to largely reduce the backward light. The elastic translucent cap 202 has a shape similar to a cylinder. Referring to FIG. 4H, the light flux at the area close to 180° is reduced. For such light pattern, the primary light-emitting ranch is roughly at 0-150°.

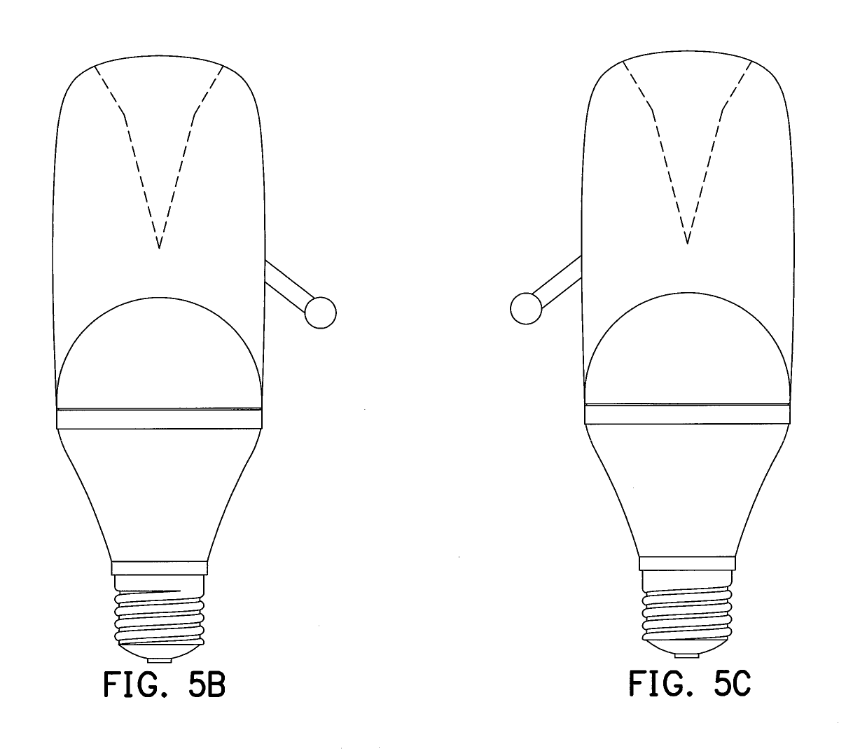

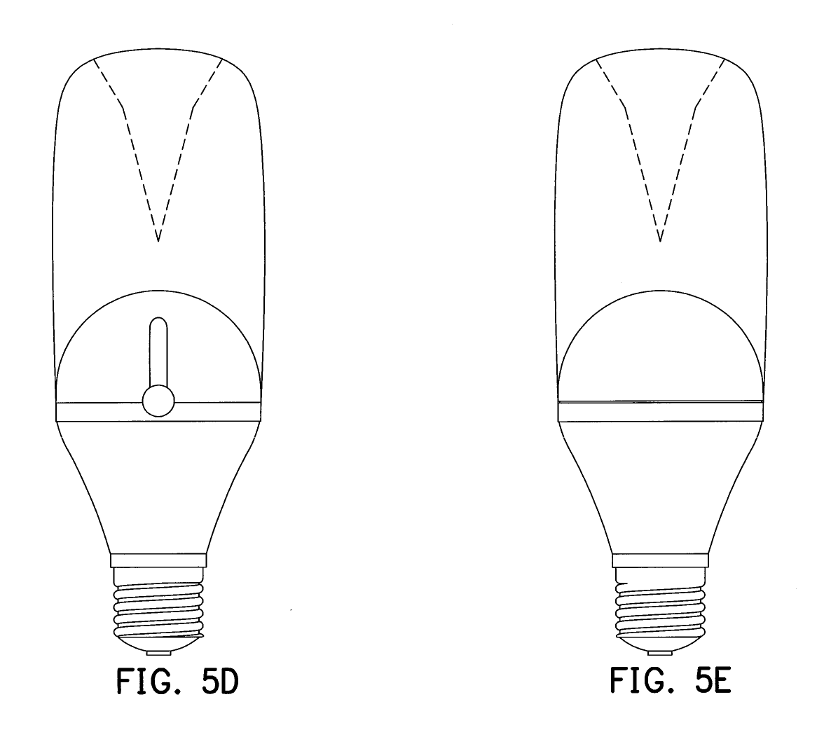

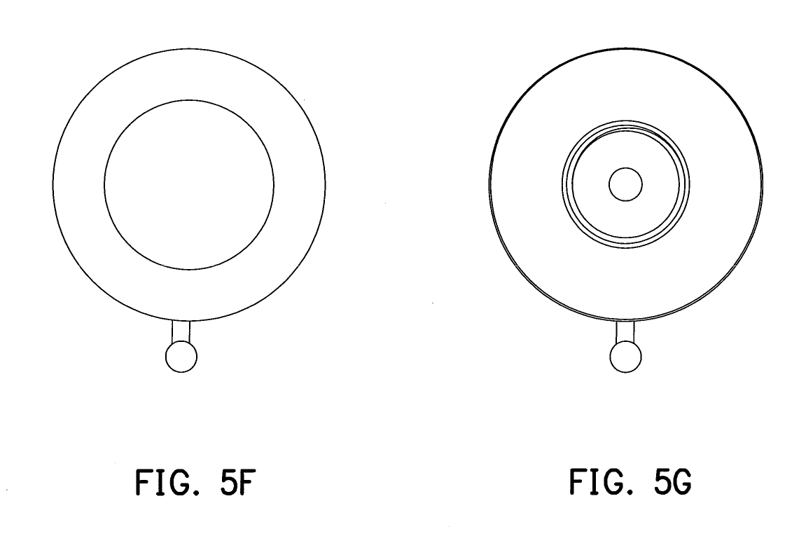

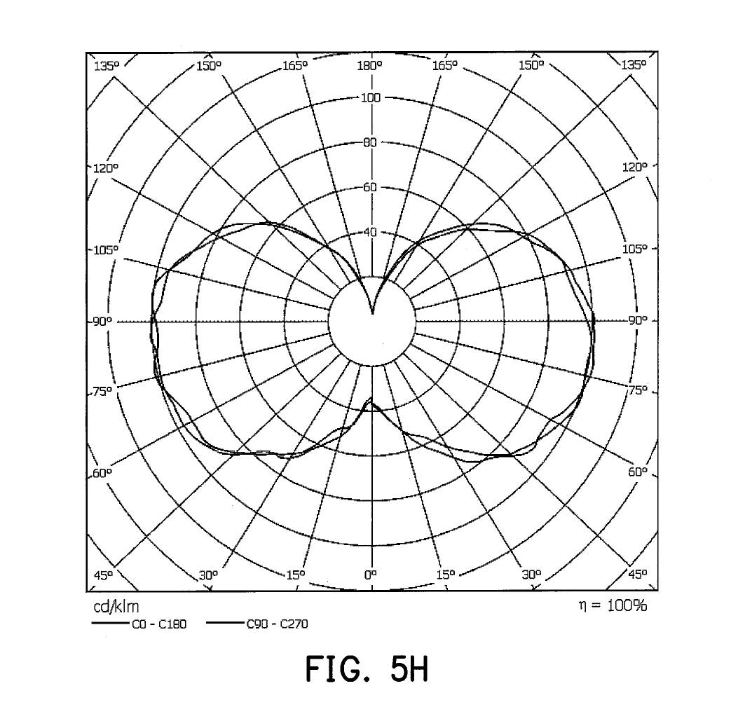

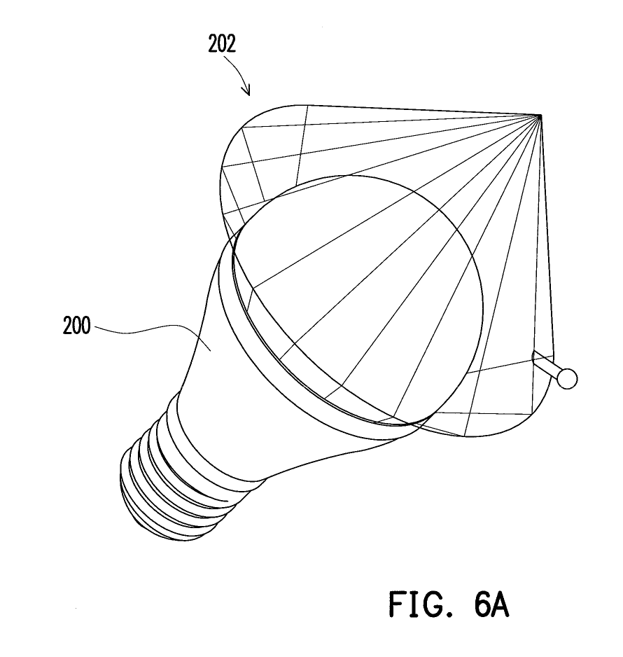

FIGS. 5A-5G are schematic diagrams showing different geometric shapes of a lamp with variable light pattern after the bulb cap is injected according to yet another embodiment of the disclosure. FIG. 5H is a schematic distribution diagram of the intensity of light according to the shape of the bulb cap in FIG. 5A.

Referring to FIGS. 5A-5G, an elastic translucent cap 202 is mounted on a lamp 200, in which the cross-section range of the elastic translucent cap 202 is not greater than the cross-section range of the lamp 200. The elastic translucent cap 202 has a shape similar to a cylinder, but has a sharp-concave structure in the middle thereof as shown by the dotted line. Referring to FIG. 5H, the light flux at the area close to 180° is reduced and meanwhile the light flux at the area close to 0° is reduced as well in comparison with the structure of FIG. 4A. For such light pattern, the primary light-emitting ranch is roughly at 60-105° to form a side light-emitting feature.

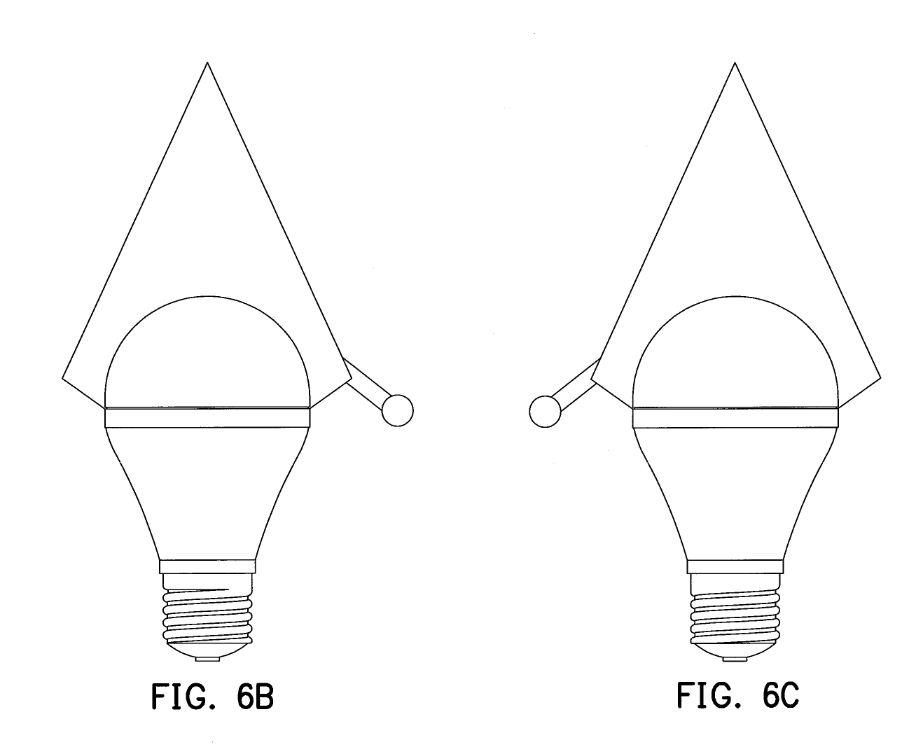

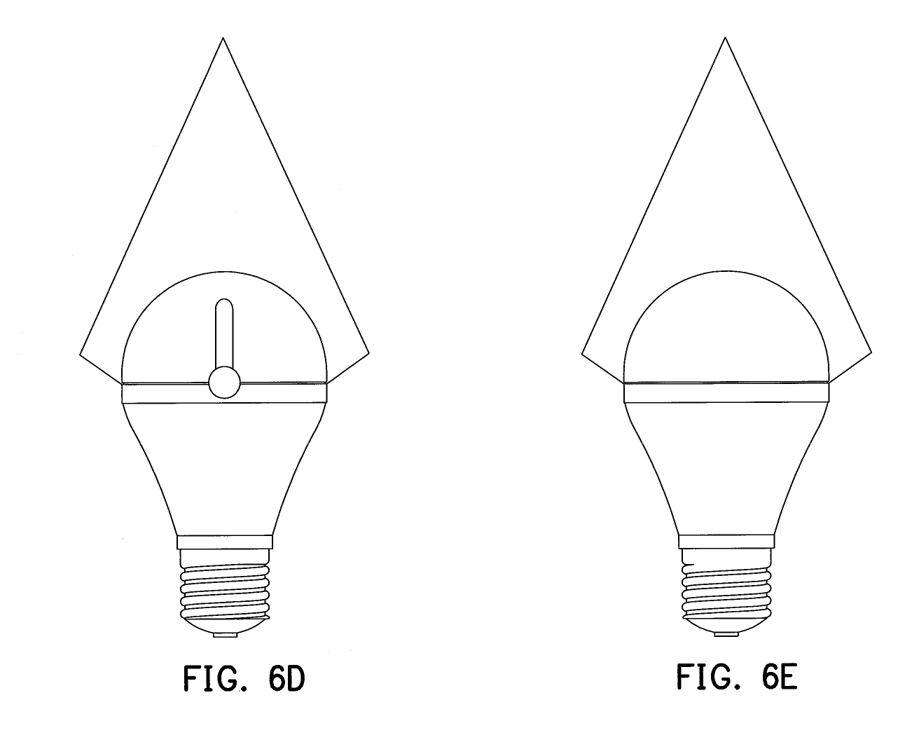

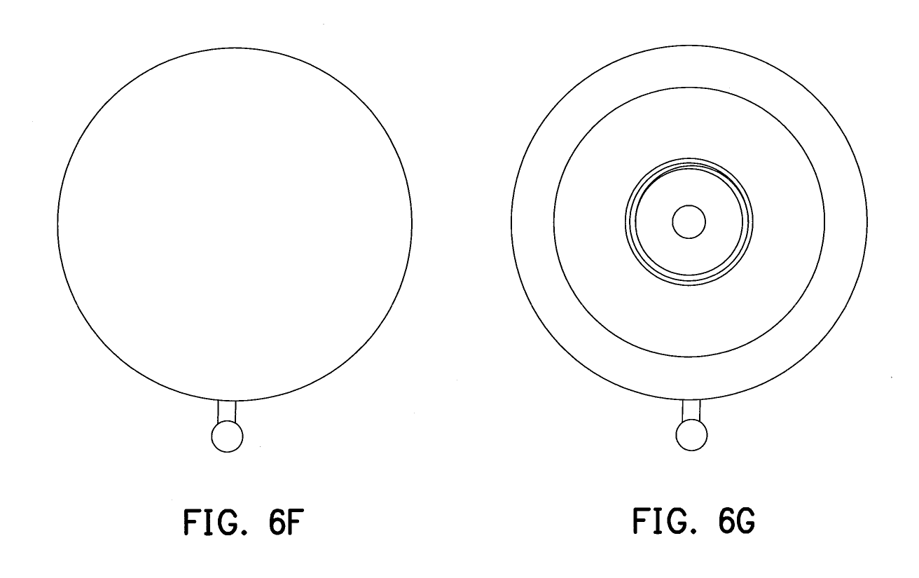

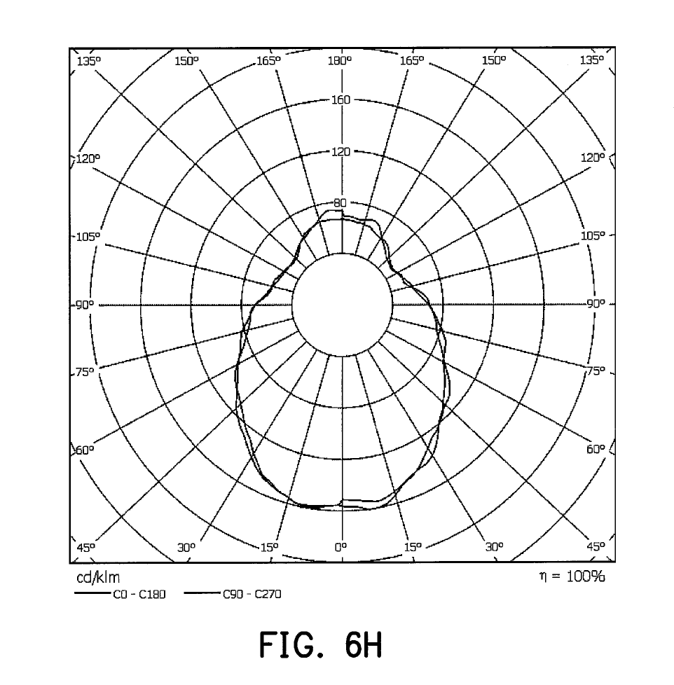

FIGS. 6A-6G are schematic perspective and 6-views diagrams showing different geometric shapes of a lamp with variable light pattern after the bulb cap is injected according to yet another embodiment of the disclosure. FIG. 6H is a schematic distribution diagram of the intensity of light according to the shape of the bulb cap in FIG. 6A.

Referring to FIGS. 6A-6G, an elastic translucent cap 202 is mounted on a lamp 200, in which the cross-section range of the elastic translucent cap 202 is greater than the cross-section range of the lamp 200. The elastic translucent cap 202 has a shape similar to a conical shape, but has a sharp-convex structure at the side thereof. Referring to FIG. 6H, the light flux at the area close to 180° is a little remained. For such light pattern, the primary light-emitting ranch is roughly at 0-45°.

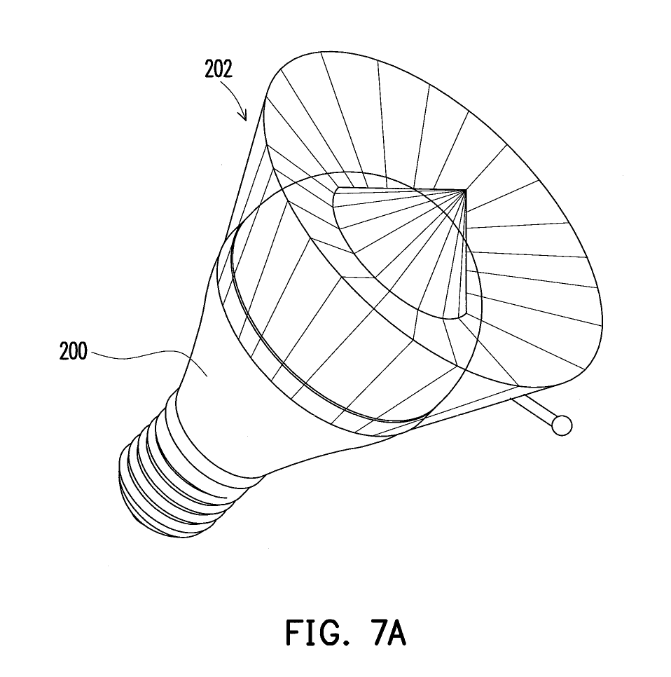

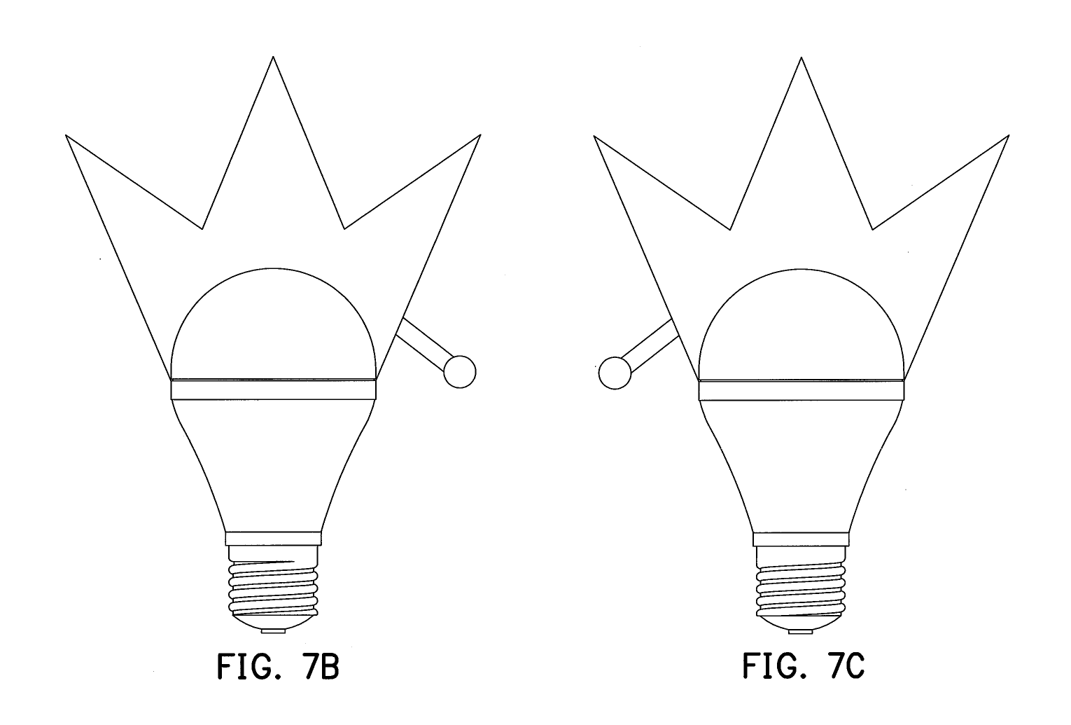

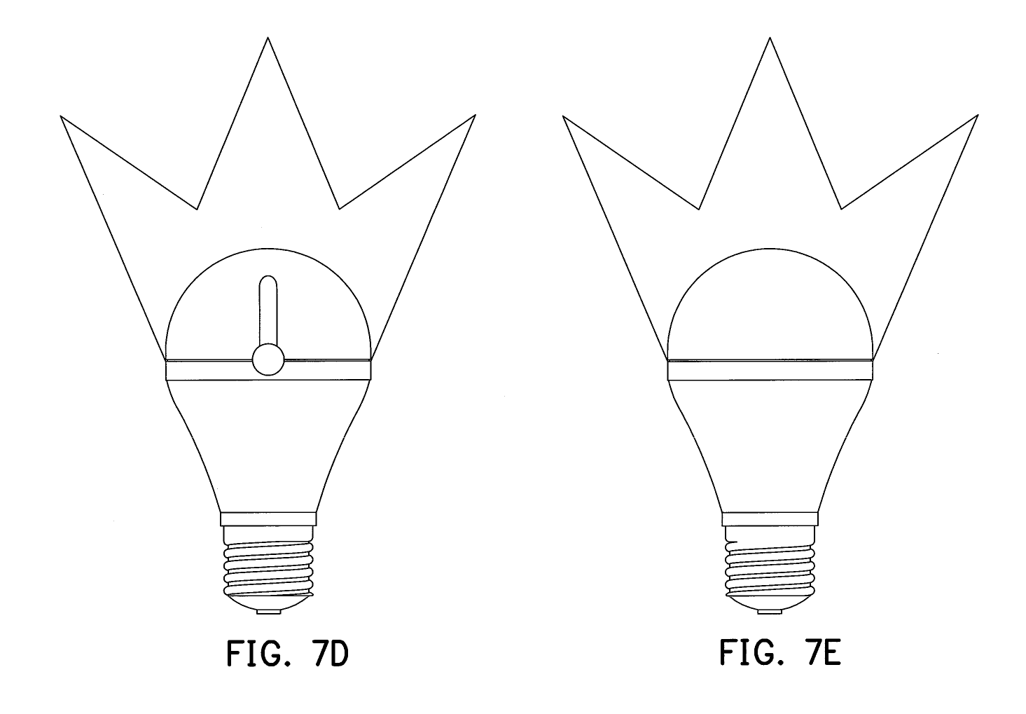

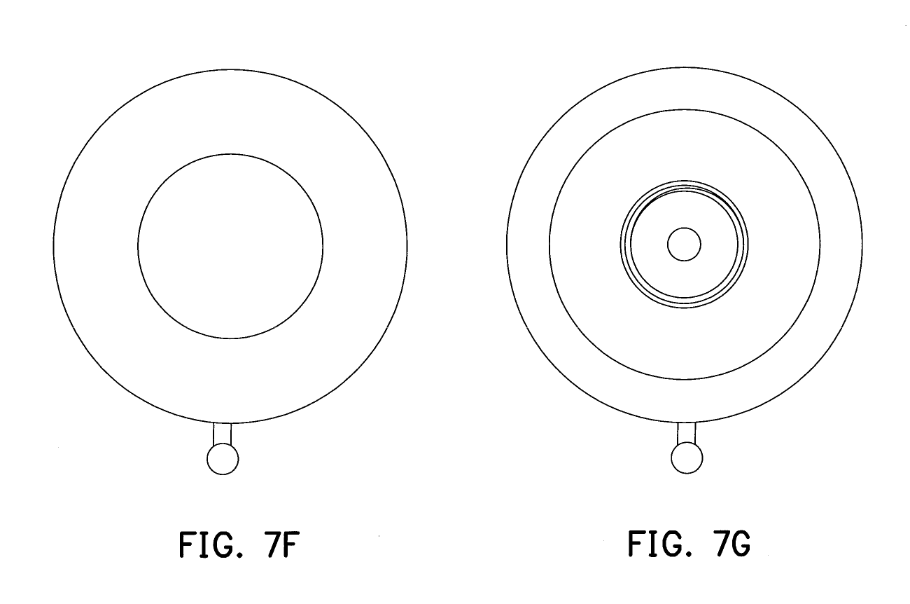

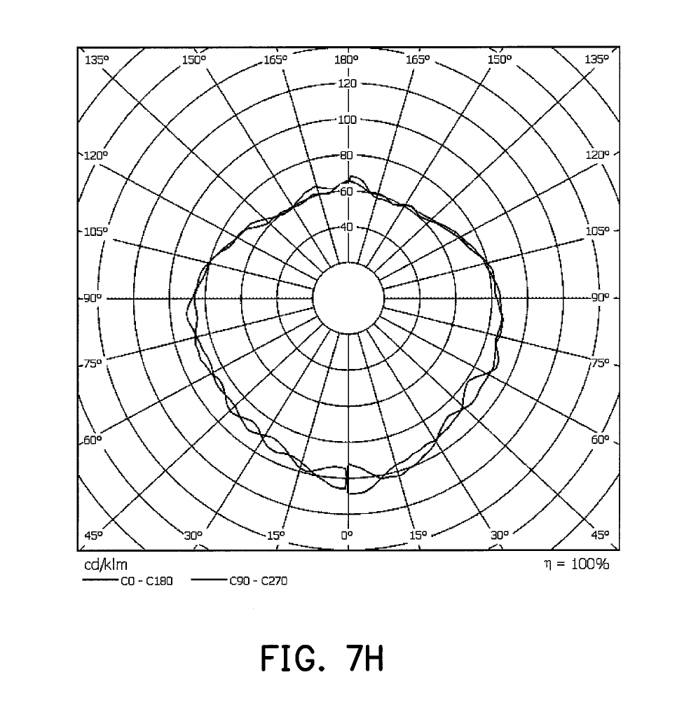

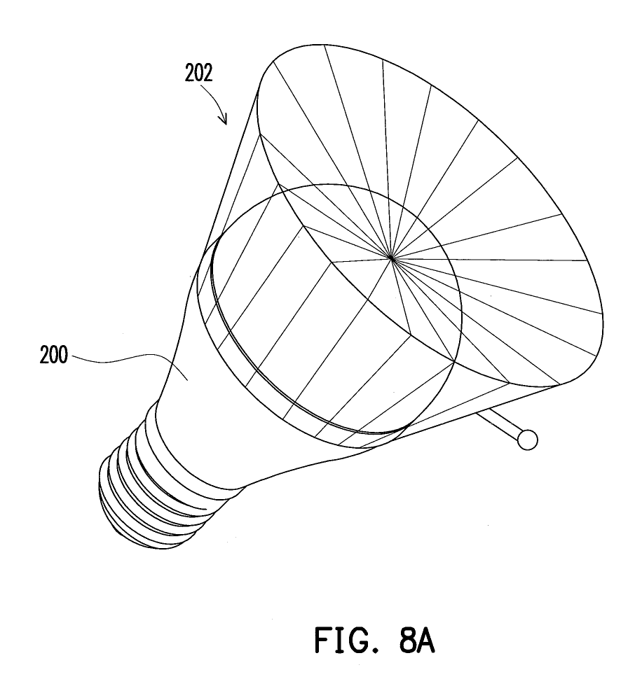

FIGS. 7A-7G are schematic perspective and 6-views diagrams showing different geometric shapes of a lamp with variable light pattern after the bulb cap is injected according to yet another embodiment of the disclosure. FIG. 7H is a schematic distribution diagram of the intensity of light according to the shape of the bulb cap in FIG. 7A.

Referring to FIGS. 7A-7G, an elastic translucent cap 202 is mounted on a lamp 200, in which the cross-section range of the elastic translucent cap 202 is greater than the cross-section range of the lamp 200. The lengthwise section of the elastic translucent cap 202 has a shape similar to W character. In other words, there are sharp-concave ring-shape grooves relatively to the central axis thereof. Referring to FIG. 7H, such specific translucent cap structure also forms specific light patterns. It should be noted that although a very sharp concave bottom and spire structure are ideally wished, but in the fabrication fact, such ideal structures are unable to be achieved. The qualitative effect, however, still remains. For the sharp structures in the following embodiment, the real fabricated shapes are somehow different from the ideal shapes as described above.

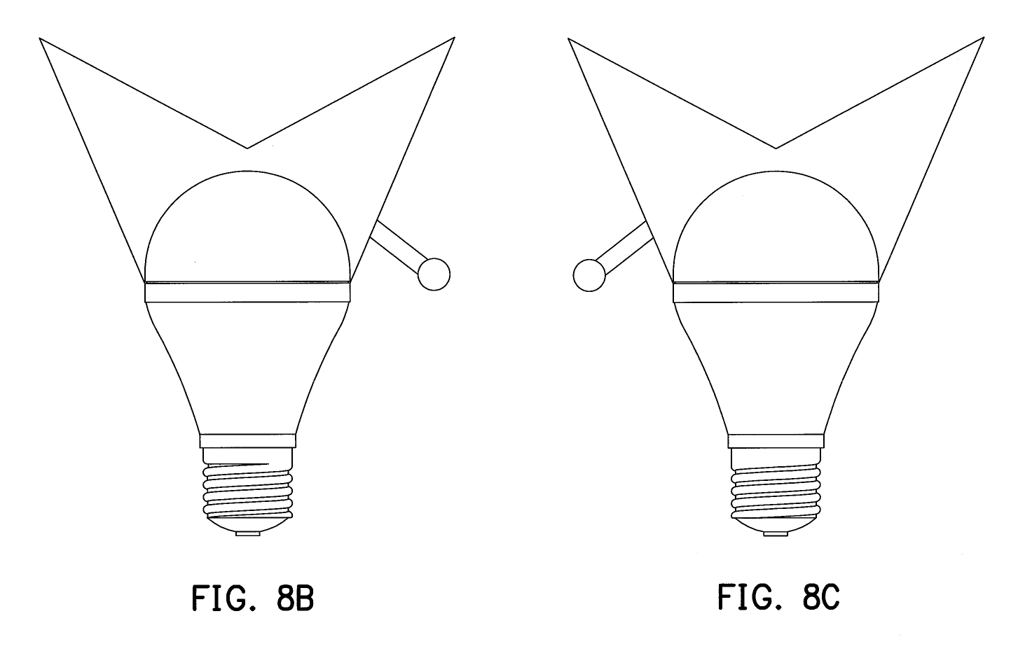

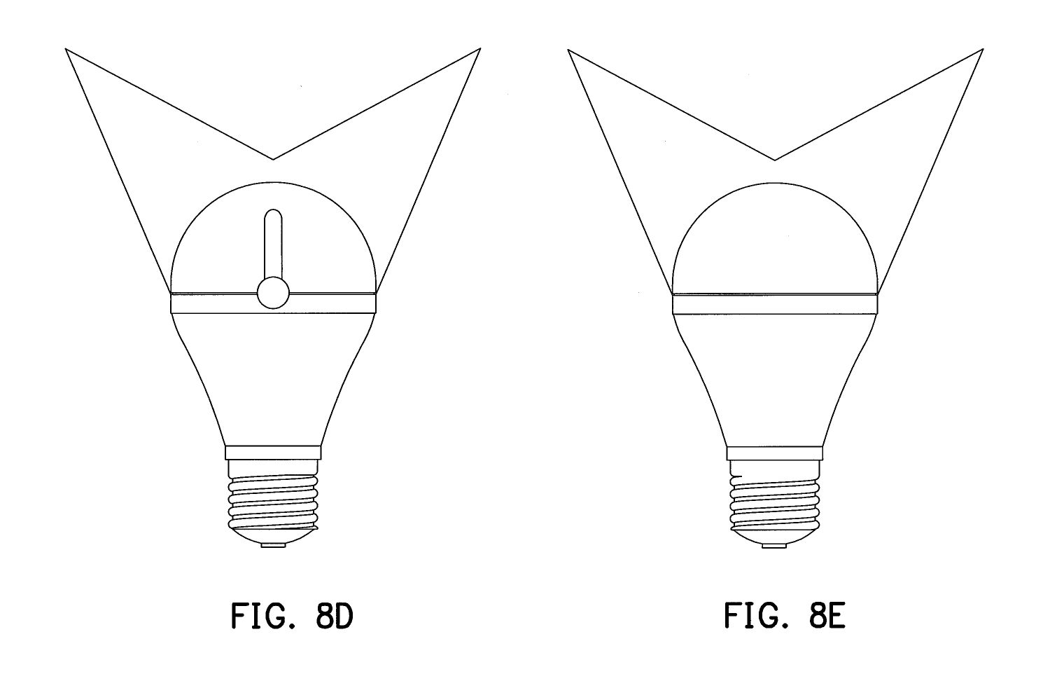

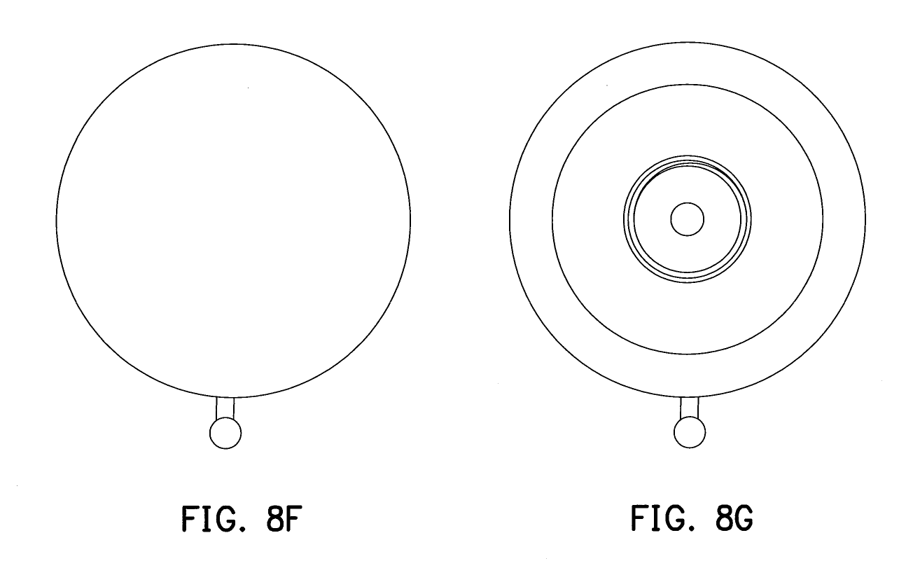

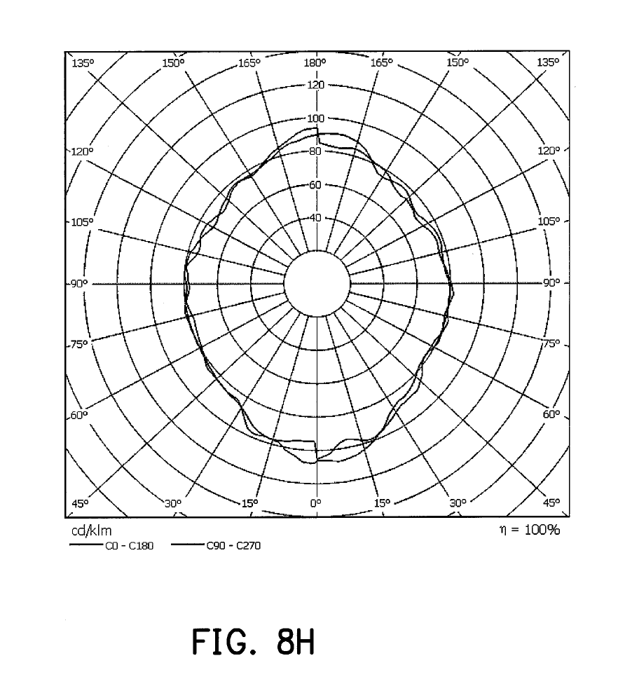

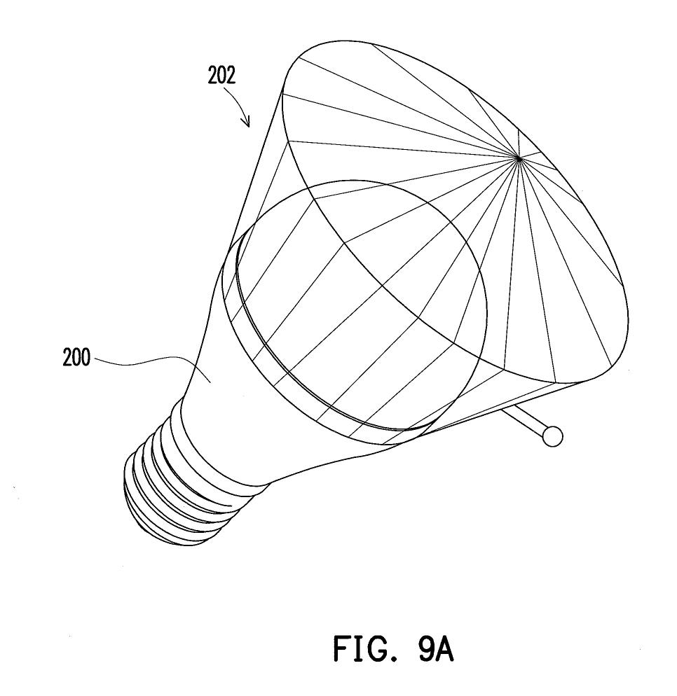

FIGS. 8A-8G are schematic perspective and 6-views diagrams showing different geometric shapes of a lamp with variable light pattern after the bulb cap is injected according to yet another embodiment of the disclosure. FIG. 8H is a schematic distribution diagram of the intensity of light according to the shape of the bulb cap in FIG. 8A.

Referring to FIGS. 8A-8G, an elastic translucent cap 202 is mounted on a lamp 200, in which the cross-section range of the elastic translucent cap 202 is greater than the cross-section range of the lamp 200. The lengthwise section of the elastic translucent cap 202 has a shape similar to V character. In other words, there is a sharp-concave structure at the center relatively to the central axis. Referring to FIG. 8H, such specific translucent cap structure also forms specific light patterns.

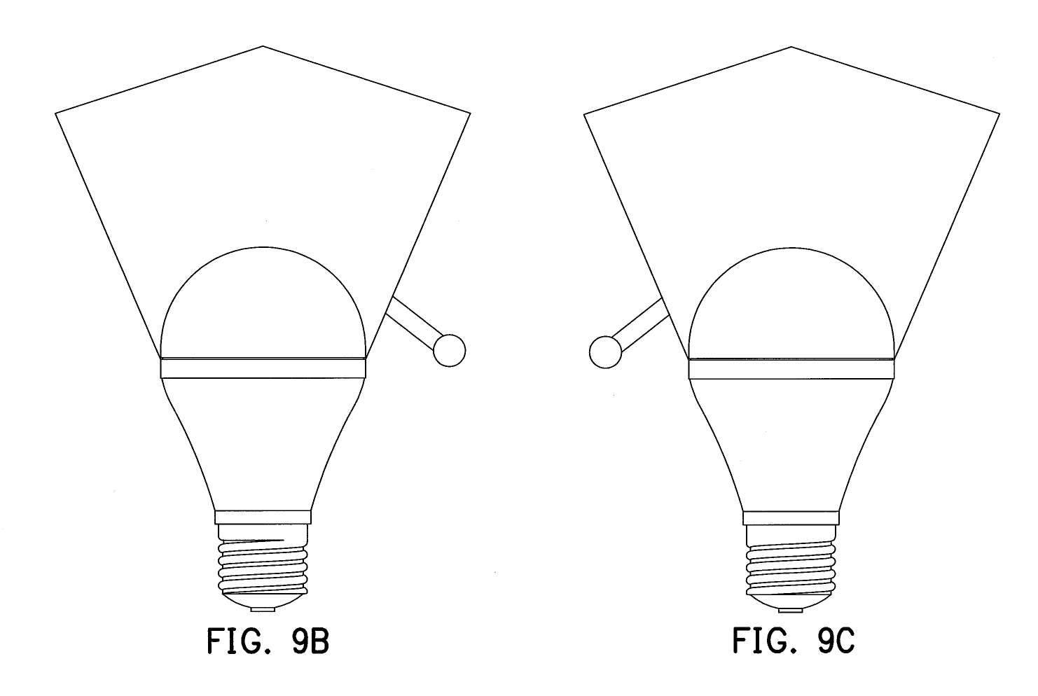

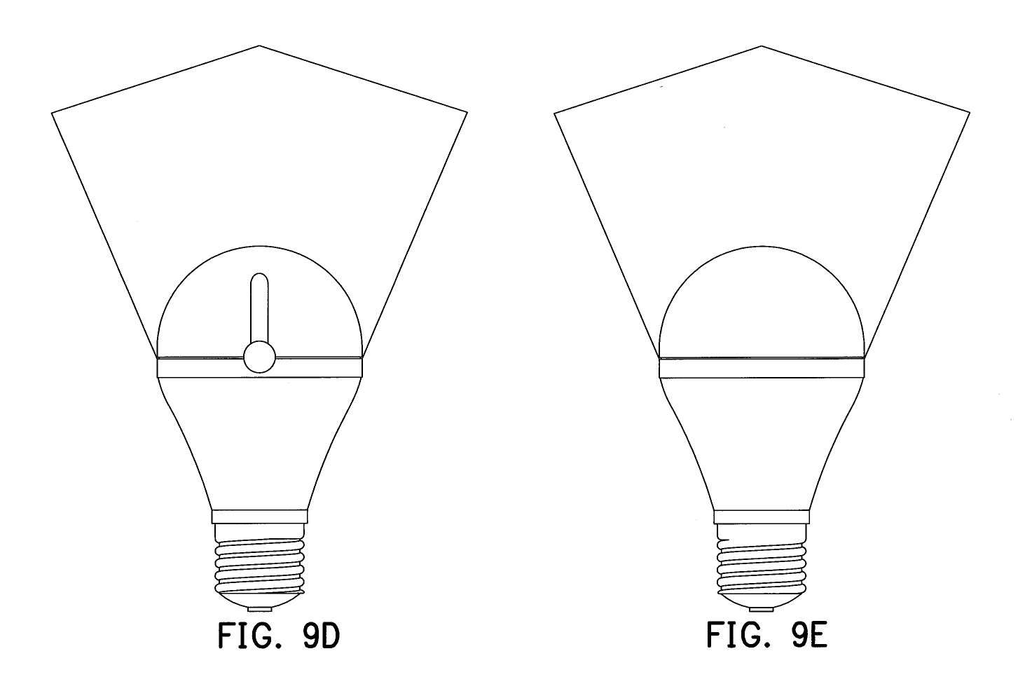

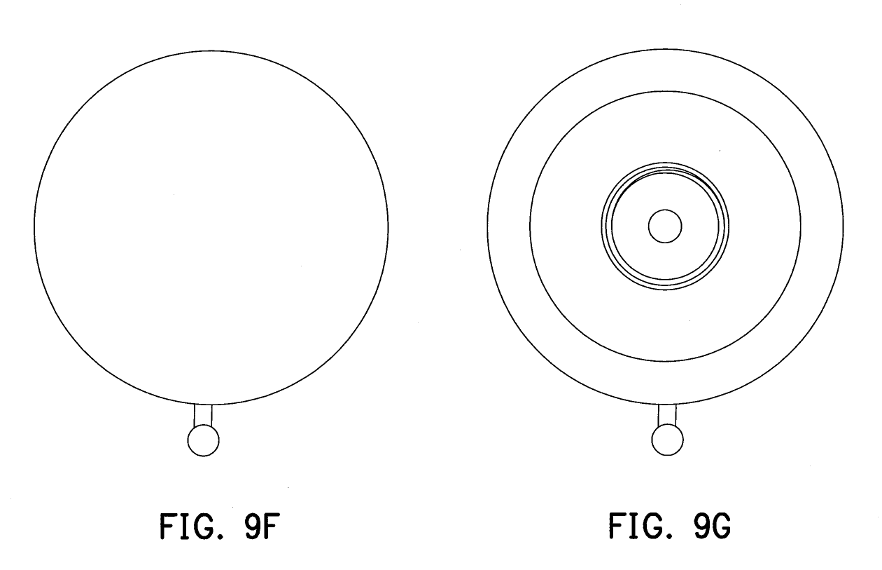

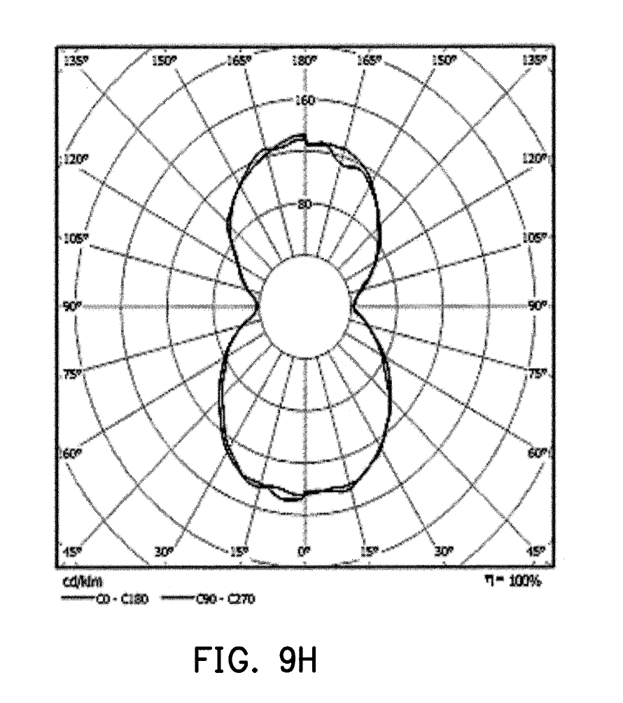

FIGS. 9A-9G are schematic perspective and 6-views diagrams showing different geometric shapes of a lamp with variable light pattern after the bulb cap is injected according to yet another embodiment of the disclosure. FIG. 9H is a schematic distribution diagram of the intensity of light according to the shape of the bulb cap in FIG. 9A.

Referring to FIGS. 9A-9G, an elastic translucent cap 202 is mounted on a lamp 200, in which the cross-section range of the elastic translucent cap 202 is greater than the cross-section range of the lamp 200. By adjusting the shape of the elastic translucent cap 202 in the embodiment, the elastic translucent cap 202 has also a sharp-convex ring shape structure at its side. Referring to FIG. 9H, such specific translucent cap structure also forms a specific light pattern mainly at the area of 0° and the area of 180°.

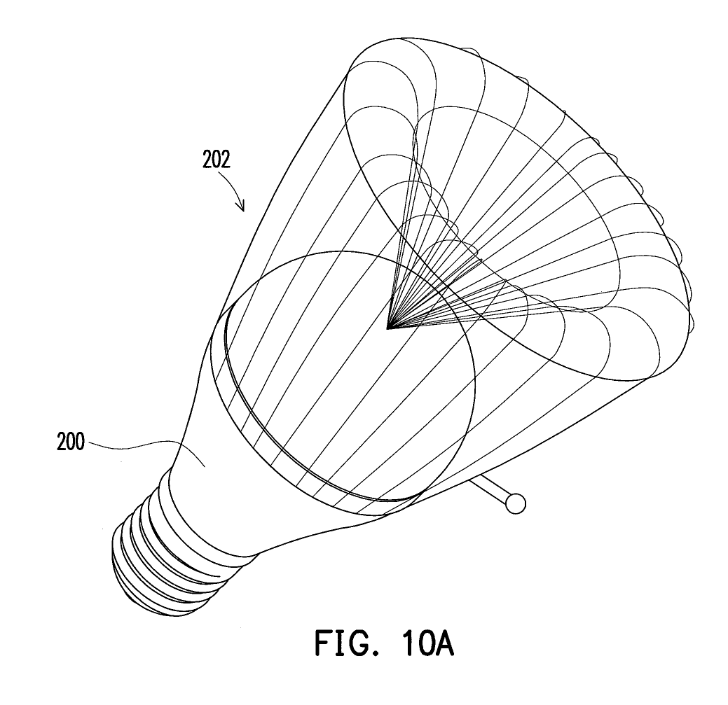

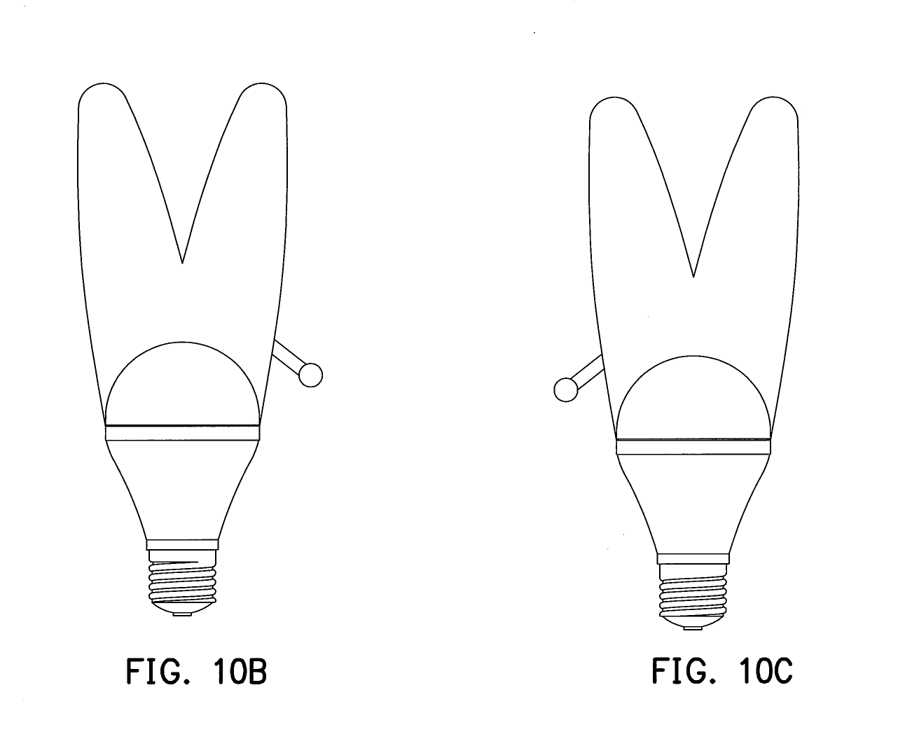

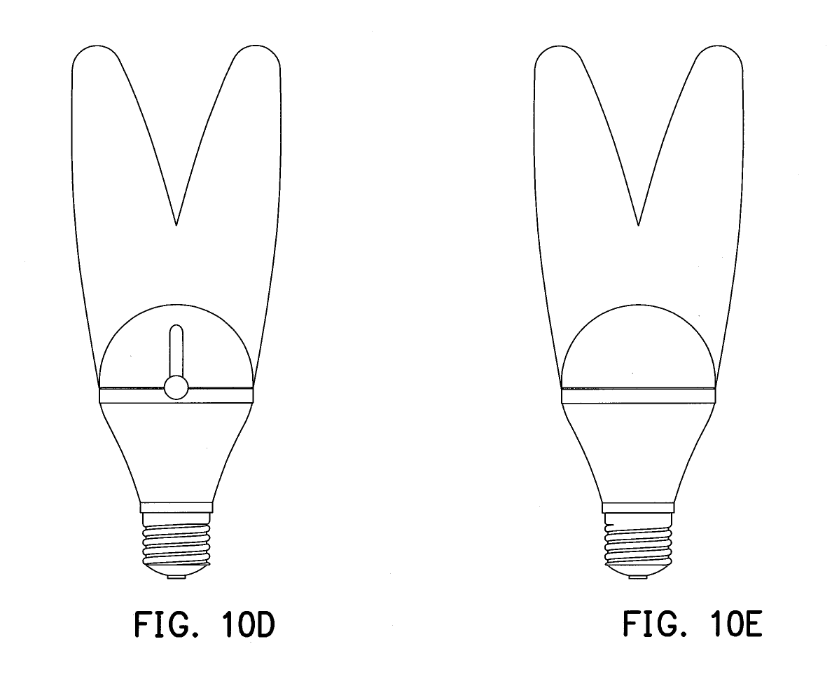

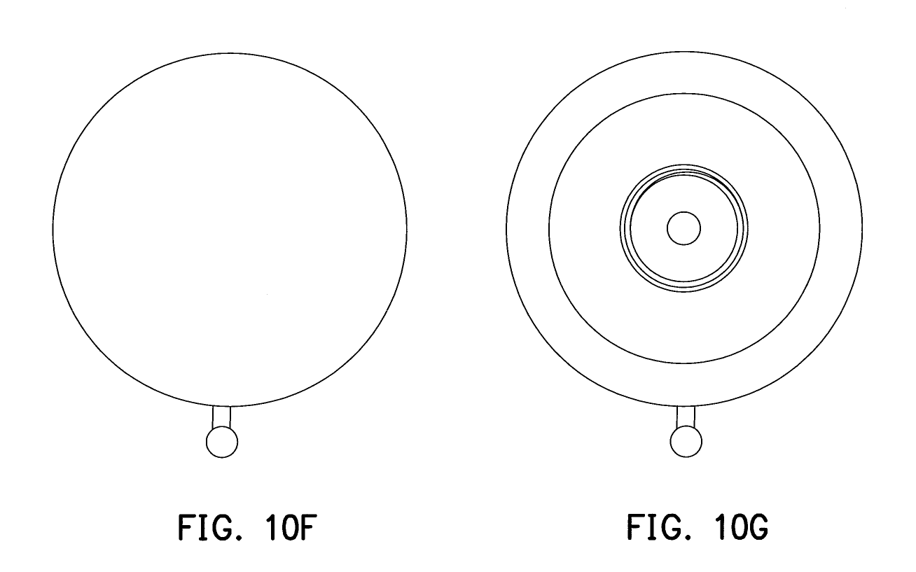

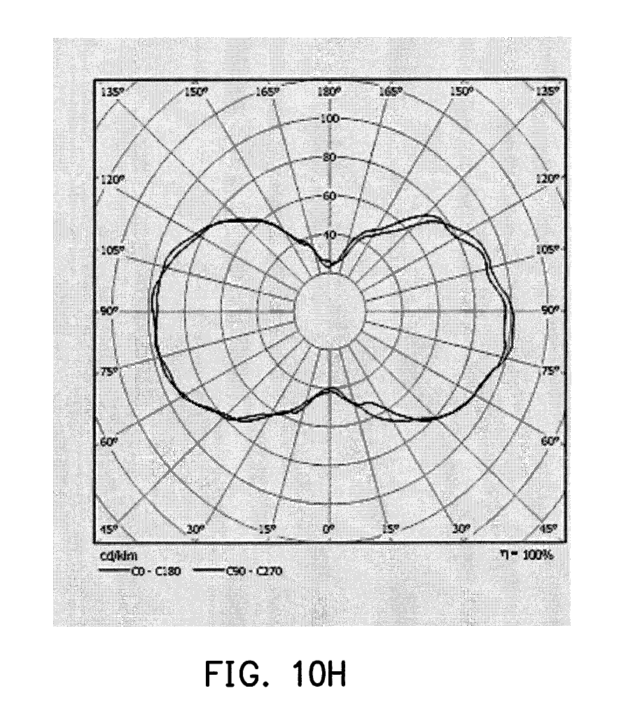

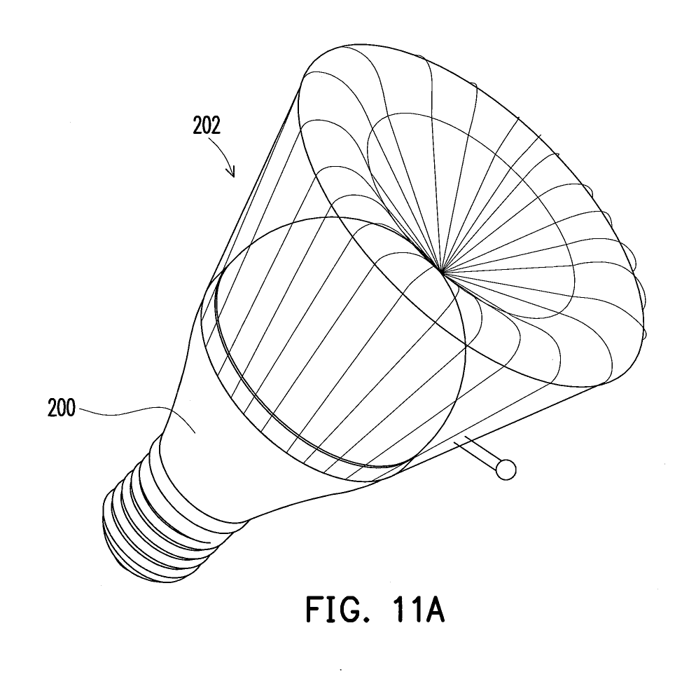

FIGS. 10A-10G are schematic perspective and 6-views diagrams showing different geometric shapes of a lamp with variable light pattern after the bulb cap is injected according to yet another embodiment of the disclosure. FIG. 10H is a schematic distribution diagram of the intensity of light according to the shape of the bulb cap in FIG. 10A.

Referring to FIGS. 10A-10G, an elastic translucent cap 202 is mounted on a lamp 200, in which the cross-section range of the elastic translucent cap 202 is greater than the cross-section range of the lamp 200. By adjusting the shape of the elastic translucent cap 202 in the embodiment, the structure at the section of the elastic translucent cap 202 includes two outward extending oblique-arm structures with more smooth profile curves. Referring to FIG. 9H, such specific translucent cap structure also forms a light pattern mainly at the area around 90°.

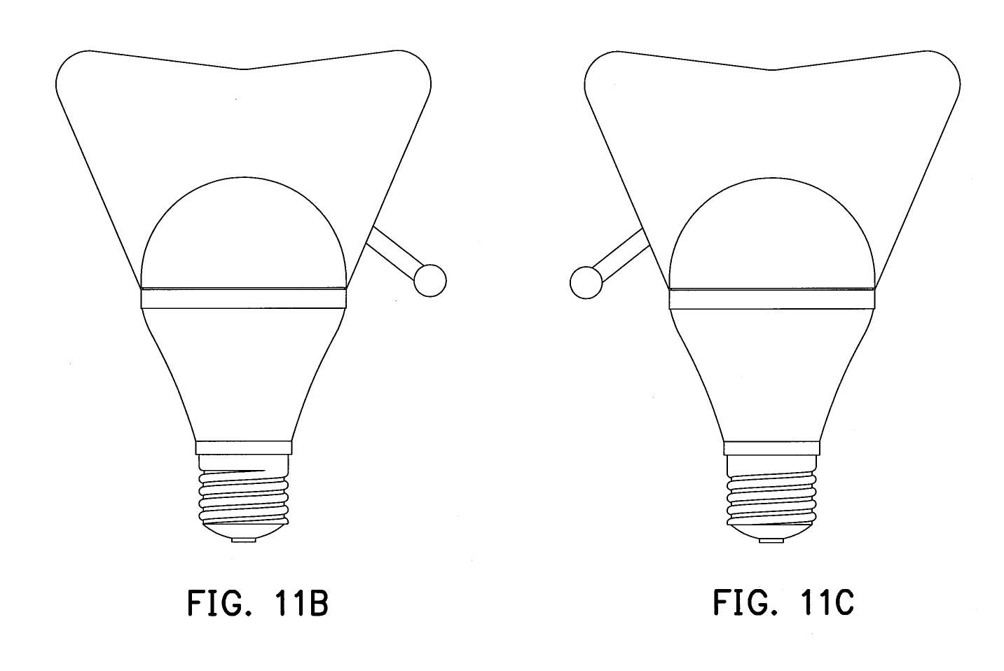

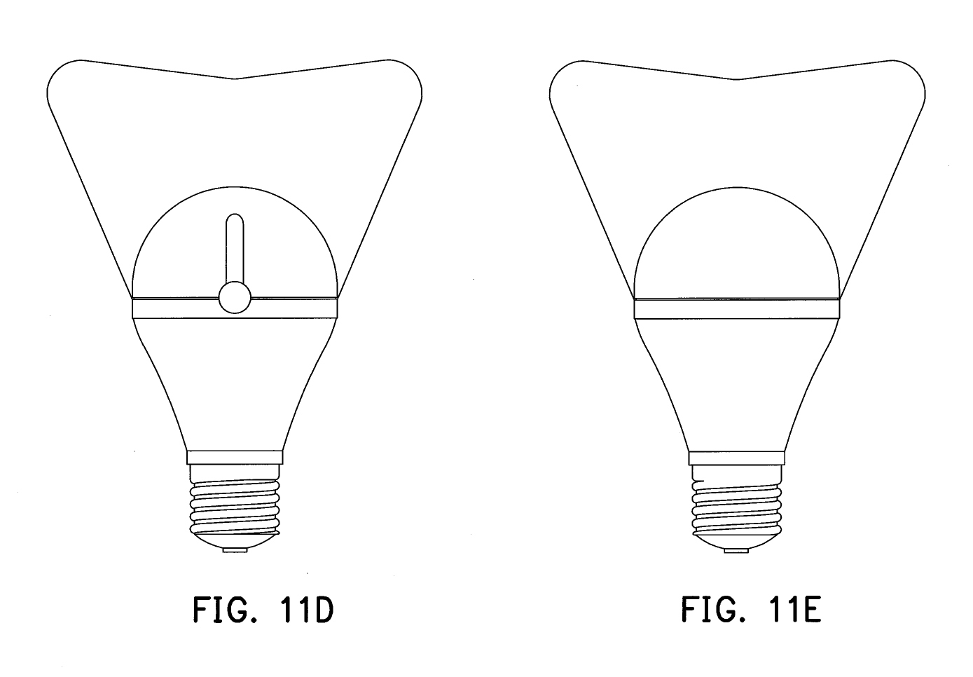

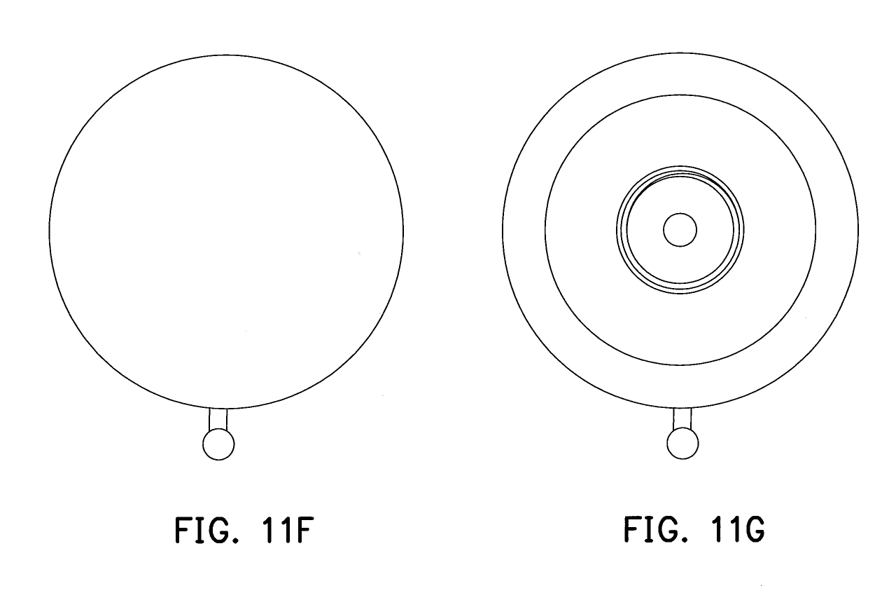

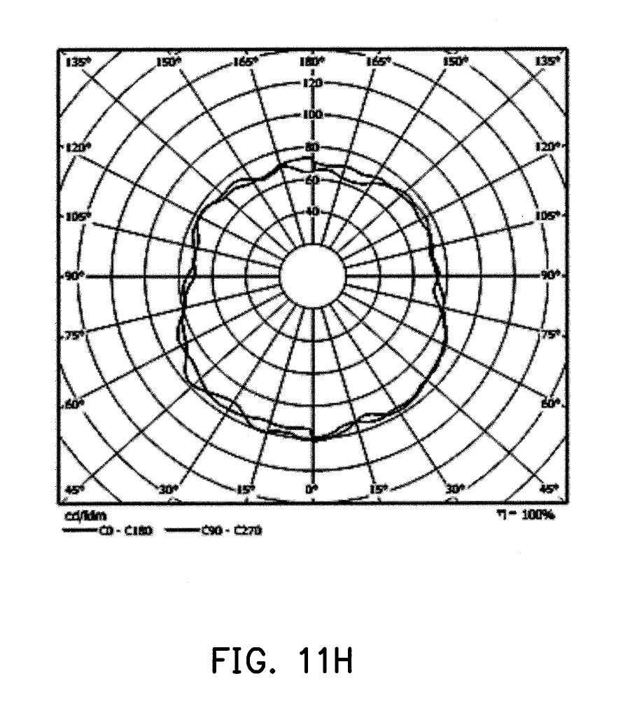

FIGS. 11A-11G are schematic perspective and 6-views diagrams showing different geometric shapes of a lamp with variable light pattern after the bulb cap is injected according to yet another embodiment of the disclosure. FIG. 11H is a schematic distribution diagram of the intensity of light according to the shape of the bulb cap in FIG. 11A.

Referring to FIGS. 11A-11G, an elastic translucent cap 202 is mounted on a lamp 200, in which the cross-section range of the elastic translucent cap 202 is greater than the cross-section range of the lamp 200. By adjusting the shape of the elastic translucent cap 202 in the embodiment, the structure at the section of the elastic translucent cap 202 also includes two outward extending oblique-arm structures, but the profile is more flat in comparison with FIG. 10A and the oblique-arm structures are not obviously intended. Referring to FIG. 11H, such specific translucent cap structure also forms a light pattern mainly at the area of 0-180°.

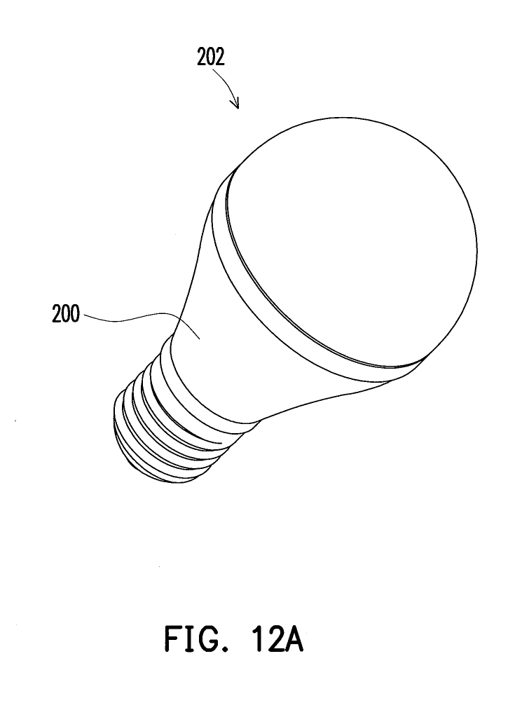

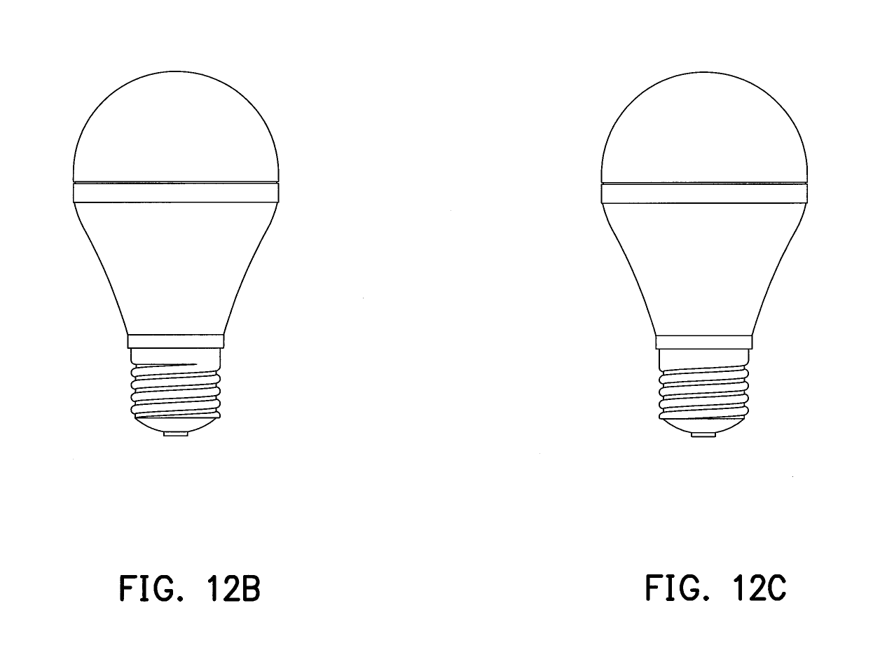

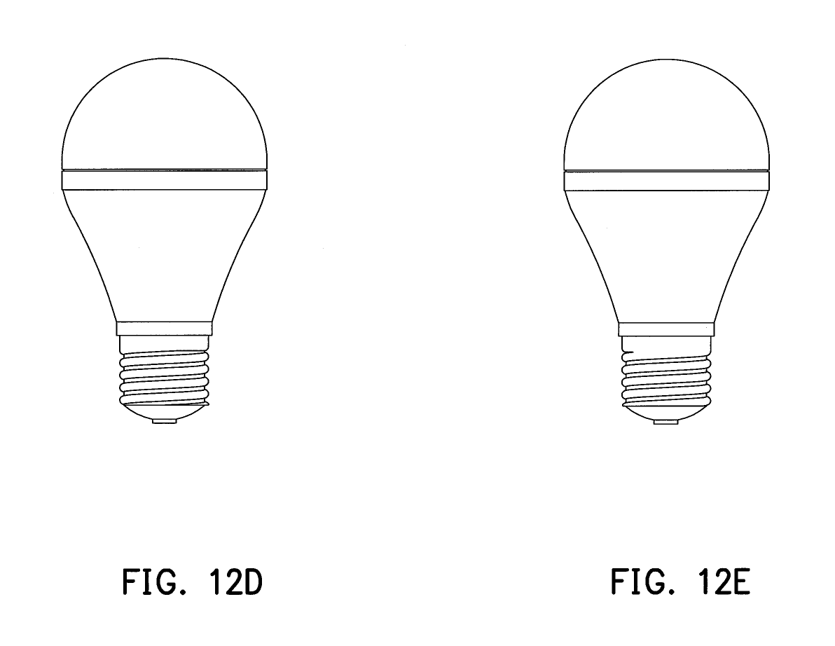

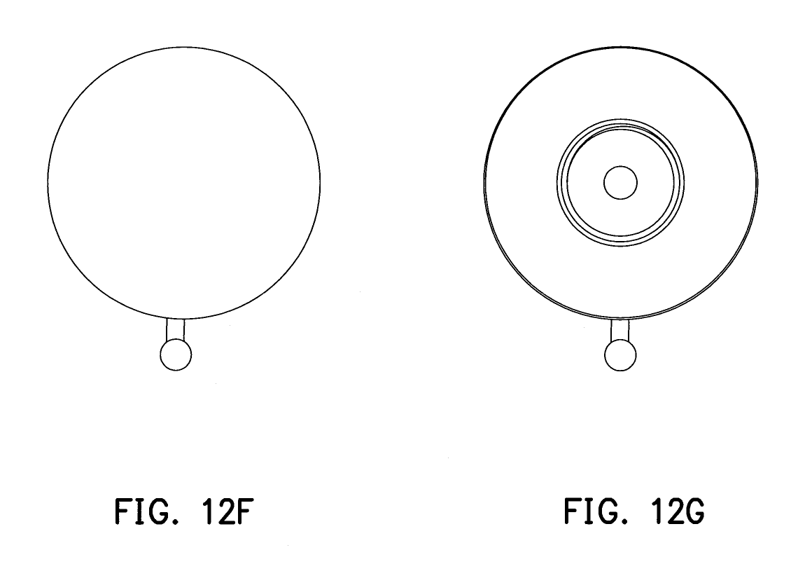

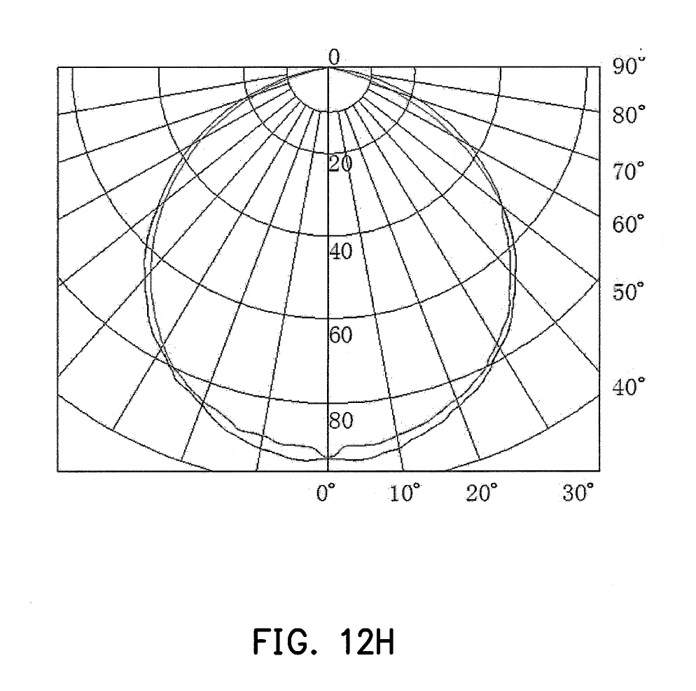

FIGS. 12A-12G are schematic perspective and 6-views diagrams showing different geometric shapes of a lamp with variable light pattern after the bulb cap is detached according to yet another embodiment of the disclosure. FIG. 12H is a schematic distribution diagram of the intensity of light according to the shape of the bulb cap in FIG. 12A.

Referring to FIGS. 12A-12C, the elastic translucent cap of the disclosure is a detachable structure, which can be assembled onto according to need and can be detached off to keep the original lamp 200 only. Referring to FIG. 12H, for the lamp 200 itself without mounting the elastic translucent cap, the light-emitting range is at 0-60°.

The above-mentioned embodiments are against an elastic translucent cap where the shape of the translucent cap can be changed with the gas-pressure variation and the light pattern thereof is changed according to the thickness distribution effect as well. However as shown by FIG. 2, the disclosure can also adopt an inelastic translucent cap.

Although the elastic translucent caps in the above-mentioned embodiments are symmetry ring-shape structures relatively to the central axis, but the disclosure also adopts non-symmetry structures relatively to the central axis.

The size of the opening of the elastic translucent cap should be adapted for the size of the lamp, for example, the size of the opening falls in a range of 30-130 mm, in which 30-70 mm, 70-130 mm or 40-60 mm may be taken. The opening can be also elastic to be easier mounted on the bulb.

The lamp adopts a luminescence light source, for example, an LED, an organic light-emitting diode (OLED) or a laser. Ant the lamp comprising LED can be, for example, an LED bulb lamp, an LED PAR lamp or an LED MR lamp.

It will be apparent to those skilled in the art that various modifications and variations can be made to the structure of the disclosed embodiments without departing from the scope or spirit of the disclosure. In view of the foregoing, it is intended that the disclosure cover modifications and variations of this disclosure provided they fall within the scope of the following claims and their equivalents.

What is claimed is:

1. A bulb cap, configured to be mounted at a base and comprising:
an elastic translucent cap, having an initial geometric shape and a thickness-distribution structure; and
a gas injecting device, coupled to the elastic translucent cap,
wherein after the elastic translucent cap is mounted on the base, gas with a gas-pressure is injected through the gas injecting device and the elastic translucent cap is expanded to a geometric shape structure corresponding to the gas-pressure to change a light pattern of the base for emitting or receiving light, the geometric shape structure varies with the gas-pressure.

2. The bulb cap as claimed in claim 1, wherein the elastic translucent cap further comprising a coupling structure disposed at an opening end of the bulb cap for mounting the elastic translucent cap at the base.

3. The bulb cap as claimed in claim 1, wherein after the elastic translucent cap is expanded by the gas-pressure, the maximal cross-section range of the elastic translucent cap is greater than a base cross-section range of the base.

4. The bulb cap as claimed in claim 1, wherein after the elastic translucent cap is expanded by the gas-pressure, the maximal cross-section range of the elastic translucent cap is not greater than a base cross-section range of the base.

5. The bulb cap as claimed in claim 1, wherein after the elastic translucent cap is expanded by the gas-pressure, a portion of the elastic translucent cap at an area of a central axis is a sharp-convex structure.

6. The bulb cap as claimed in claim 5, wherein a sectional structure line from the sharp-convex structure to a coupling structure is a smooth convex curve, wherein the coupling structure is disposed at an opening end of the bulb cap for mounting the elastic translucent cap at the base.

7. The bulb cap as claimed in claim 5, wherein a sectional structure line from the sharp-convex structure to a coupling structure has a convex sharp-angle structure, wherein the coupling structure is disposed at an opening end of the bulb cap for mounting the elastic translucent cap at the base.

8. The bulb cap as claimed in claim 1, wherein after the elastic translucent cap is expanded by the gas-pressure, a portion of the elastic translucent cap at an area of a central axis is a dent structure.

9. The bulb cap as claimed in claim 8, wherein a sectional structure line from the dent structure to a coupling structure is an outward extending oblique-arm structure, wherein the coupling structure is disposed at an opening end of the bulb cap for mounting the elastic translucent cap at the base.

10. The bulb cap as claimed in claim 1, wherein after the elastic translucent cap is expanded by the gas-pressure, the bulb cap comprises a groove surrounding a lengthwise central axis of the base.

11. The bulb cap as claimed in claim 1, wherein after the elastic translucent cap is expanded by the gas-pressure, the elastic translucent cap is symmetric relatively to a lengthwise central axis of the base.

12. A lamp, comprising:
a bulb;
an elastic translucent cap, having an initial geometric shape and a thickness-distribution structure; and
a gas injecting device, coupled to the elastic translucent cap,
wherein after the elastic translucent cap is mounted on the bulb, gas with a gas-pressure is injected through the gas injecting device, the elastic translucent cap is expanded to a geometric shape structure corresponding to the gas-pressure to change a light pattern of the bulb, and the geometric shape structure varies with the gas-pressure.

13. The lamp as claimed in claim 12, wherein the elastic translucent cap further comprising a coupling structure disposed at an opening end of the elastic translucent cap for mounting the elastic translucent cap at the bulb to serve as a bulb cap.

14. The lamp as claimed in claim 12, wherein after the elastic translucent cap is expanded by the gas-pressure, the maximal cross-section range of the elastic translucent cap is greater than a bulb cross-section range of the bulb.

15. The lamp as claimed in claim 12, wherein after the elastic translucent cap is expanded by the gas-pressure, the maximal cross-section range of the elastic translucent cap is not greater than a bulb cross-section range of the bulb.

16. The lamp as claimed in claim 12, wherein after the elastic translucent cap is expanded by the gas-pressure, a portion of the elastic translucent cap at an area of a central axis is a sharp-convex structure.

17. The lamp as claimed in claim 12, wherein a sectional structure line from the sharp-convex structure to the coupling structure is a smooth convex curve.

18. The lamp as claimed in claim 12, wherein a sectional structure line from the sharp-convex structure to the coupling structure has a convex sharp-angle structure.

19. A bulb cap, configured to be mounted at a base and comprising:
a bulb cap, having a geometric shape structure and to be mounted on the base,
wherein after the bulb cap is mounted on the base, the geometric shape structure changes the light pattern of the base for emitting or receiving light.

20. A lamp, comprising:
a bulb;
a bulb cap, having a geometric shape structure and to be mounted on the bulb,
wherein after the bulb cap is mounted on the bulb, the geometric shape structure changes a light pattern of the bulb.
